(19) United States
(12) Patent Application Publication
(10) Pub. No.: US 2026/0021347 A1
(43) Pub. Date: Jan. 22, 2026

(54) SYSTEM AND METHOD FOR ANALYZING MOVEMENT OF A NON-SPHERICAL OBJECT

(71) Applicant: TRACKMAN A/S, Hørsholm (DK)

(72) Inventors: Kasper MACKEPRANG, Hørsholm (DK); Fredrik TUXEN, Rungsted Kyst (DK); Phillip ROSASCO-ANDERSEN, Hørsholm (DK)

(21) Appl. No.: 18/901,741

(22) Filed: Sep. 30, 2024

Related U.S. Application Data
(63) Continuation-in-part of application No. 18/779,816, filed on Jul. 22, 2024, now abandoned.

(51) Int. Cl. A63B 24/00; G06T 7/246; G06T 7/60

(52) U.S. Cl. CPC A63B 24/0021; G06T 7/248; G06T 7/60; A63B 2024/0034; A63B 2220/05

(57) ABSTRACT

A system includes a tracking device generating data corresponding to range/range rate of the object passing through a device field view; an imager having a field view at least partially overlapping with the device field view and generating object's images; and a processor detecting the object in each image and a mass center of object portions. The processor identifies the center and constructs a composite image including portions of selected images so that the center is located at the same position in the composite image. The processor identifies a point on the object in each portion and determines a displacement of the point relative to the center. The processor determines, using data from the device and the displacement, a wobbling angle of the object corresponding to an angle between a rotation plane of object's major axis and a travel direction along which the center are moving.

### PRIORITY CLAIM

The present application claims priority to and is a Continuation-in-Part of U.S. patent application Ser. No. 18/779,816 filed Jul. 22, 2024; the disclosure of which is incorporated herewith by reference.

### BACKGROUND

Spin parameters, such as a spin rate of a spherically shaped sports ball, are highly useful for tracking a launch of the sports ball and providing metrics related to the launch to interested parties. Determining the spin rate of a spherical sports ball is described in the art, for example, in U.S. Pat. No. 8,845,442. However, a non-spherically shaped sports ball may have multiple independent spin parameters, making the derivation of spin metrics more difficult. It is not presently known in the art how to determine a spin rate of a non-spherical ball when the spin changes the apparent orientation of the ball, i.e., causes the ball to “topple.” An example of a toppling spin is a typical kick in American football, where the football almost always has a portion of “over the top,” i.e., “toppling,” rotation. A determination of the toppling frequency for kicks in American football is highly relevant for determining the factors that influence the flight of the kicked ball. Kickers often refer to the toppling frequency from visual inspection of the flight and use this as one of the criteria for determining if the kick was successfully executed or not.

### SUMMARY

The present disclosure relates to an imaging system for determining a wobbling angle of a spinning non-spherical object. The system includes an imaging device having a field of view through which the spinning non-spherical object passes along a flight path, the imaging device being configured to generate a series of images of the spinning non-spherical object; and a processor connected to the imaging device. The processor is configured to: determine, for at least one image of the spinning non-spherical object, a center of the spinning non-spherical object; determine a predetermined characteristic point on the spinning non-spherical object for the at least one image; determine a displacement of the predetermined characteristic point on the spinning non-spherical object relatively to the center of the spinning non-spherical object; determine a distance from the imager to the predetermined characteristic point on the spinning non-spherical object; and determine the wobbling angle based on the displacement of the predetermined characteristic point and the distance from the imager to the predetermined characteristic point on the spinning non-spherical object.

In an embodiment, the processor is configured to identify in each image a subset of pixels representing an outline of the non-spherical object and determine the center of the spinning non-spherical object from the outline determined.

In an embodiment, the processor is configured to determine the wobbling angle for one or more further images.

In an embodiment, the processor is configured to determine an average value for the wobbling angle.

In addition, the present disclosure relates to a method for determining a wobbling angle of a spinning non-spherical object. The methos includes generating a series of images of the spinning non-spherical object in flight; determining, for at least one image of the spinning non-spherical object, a center of the spinning non-spherical object; determining a predetermined characteristic point on the spinning non-spherical object for the at least one image; determining a displacement of the predetermined characteristic point on the spinning non-spherical object relative to the center of the spinning non-spherical object; determining a distance from an imager to the predetermined characteristic point on the spinning non-spherical object; and determining the wobbling angle based on the displacement of the predetermined characteristic point and the distance from the imager to the predetermined characteristic point on the spinning non-spherical object.

In an embodiment, the method further includes placing the imager substantially behind a sportsman throwing the non-spherical object for detecting the amount of wobbling for the thrown non-spherical object.

In an embodiment, the method further includes identifying in each image a subset of pixels representing an outline of the non-spherical object; and determining the center of the spinning non-spherical object from the outline determined.

In an embodiment, the method further includes determining the wobbling angle for the one or more further images.

In an embodiment, the method further includes determining an average value for the determined wobbling angles.

In an embodiment, the non-spherical object is one of an American football, an Australian football, and a Rugby ball.

In addition, the present disclosure relates to an imaging system for determining a wobbling angle of a spinning non-spherical object. The system includes an imaging device having a field of view through which the spinning non-spherical object passes along a travelling direction, the imaging device being configured to generate a series of images of the spinning non-spherical object; and a processor connected to the imaging device. The processor is configured to: determine a predetermined characteristic line for the spinning non-spherical object for a plurality of the images; determine the travelling direction of the spinning non-spherical object for the plurality of the images; and determine the wobbling angle as an angle between the travelling direction and the predetermined characteristic line of the spinning non-spherical object.

In an embodiment, the spinning non-spherical object is a sport ball having a minor and a major axis; and wherein the predetermined characteristic line is the major axis of the sport ball.

In an embodiment, an imager is placed substantially orthogonal to a travelling path of the non-spherical object thrown by a sportsman.

Furthermore, the present disclosure relates to a method for determining a wobbling angle of a spinning non-spherical object. The method includes generating a series of images of the spinning non-spherical object; determining a predetermined characteristic line for the spinning non-spherical object for a plurality of the images; determining a travelling direction of the spinning non-spherical object for the plurality of the images; and determining the wobbling angle as an angle between the travelling direction and the predetermined characteristic line of the spinning non-spherical object.

In an embodiment, the spinning non-spherical object is a sport ball having a minor and a major axis; and wherein the predetermined characteristic line is the major axis of the sport ball.

In an embodiment, the method further includes placing an imager substantially orthogonal to a travelling path of the non-spherical object thrown by a sportsman.

In addition, the present disclosure relates to an imaging system for determining a toppling axis of a non-spherical object in flight. The system includes an imaging device having a field of view through which the non-spherical object in flight passes, the imaging device being configured to generate a series of images of the non-spherical object in flight; and a processor connected to the imaging device. The processor is configured to determine a center of the non-spherical object in flight in a sequence of images; determine a predetermined characteristic point on the non-spherical object in flight for images in the sequence of images; determine a travelling path of the characteristic point on the non-spherical object in flight for images in the sequence of images; and determine a toppling axis to have a toppling angle determined as the angle between the travelling path of the characteristic point on the non-spherical object and vertical.

In an embodiment, the processor is configured to identify whether the non-spherical object is toppling.

In an embodiment, the processor is configured to form an “X” based on based on two travelling paths for two characteristic points on the non-spherical object in flight and the corresponding outline of the non-spherical object in flight and determine an offset angle to be half of an opening angle of the “X”.

In addition, the present disclosure relates to a method for determining a toppling axis of a spinning non-spherical object. The method includes generating a series of images of the non-spherical object in flight; determining a center of the non-spherical object in flight in a sequence of images; determining a predetermined characteristic point on the non-spherical object in flight for images in the sequence of images; determining a travelling path of the characteristic point on the non-spherical object in flight for images in the sequence of images; and determining a toppling axis to have a toppling angle determined as the angle between the travelling path of the characteristic point on the non-spherical object and vertical.

In an embodiment, the method further includes identifying whether the non-spherical object is furthermore toppling.

In an embodiment, the method further includes forming an “X” based on based on two travelling paths for two characteristic points on the non-spherical object in flight and the corresponding outline of the non-spherical object in flight, and determining an offset angle for a toppling axis to be half of an opening angle of the “X”.

In an embodiment, the non-spherical object is one of an American football, an Australian football, and a Rugby ball.

In addition, the present disclosure relates to a system for determining flight characteristics of a non-spherical object. The system includes a tracking device generating data corresponding to one of a range and a range rate of a non-spherical object passing through a field of view of the tracking device; an imager having a field of view that at least partially overlaps with the field of view of the tracking device in an overlap field of view; the imager generating images of the non-spherical object as it traverses the overlap field of view; and a processor receiving images from the imager and the tracking device, the processor being configured to detect the non-spherical object in each of a plurality of the images and to detect a center of mass of object portions of each of the images. The object portion of each of the images is a portion of each image showing the non-spherical object, the processor being configured to identify a center of mass of each of the object portions and to construct a composite image including the object portions of selected ones of the images, the composite image being generated so that the center of mass of each object portion is located at the same position in the composite image, the processor identifying a first point on the non-spherical object in each of the object portions and determining a displacement of the first point relative to the center of mass in each of the object portions, the processor determining, based on the data from the tracking device and the displacement of the first point, a wobbling angle of the non-spherical object corresponding to an angle between a plane of rotation of a major axis of the non-spherical object and a travel direction along which the center of mass of the object portions are moving.

In an embodiment, the processor is configured to identify the object portion of each image by identifying a subset of pixels representing an outline of the non-spherical object, the processor identifying the center of mass each of the object portions based on the outline.

In an embodiment, the processor is configured to determine an average value for the wobbling angle through a portion of movement of the non-spherical object represented by the images.

In an embodiment, the processor is further configured to determine a distance from the imager to the first point on the non-spherical object; and determine the wobbling angle based on the displacement of the first point and the distance from the imager to the first point.

In an embodiment, when the non-spherical object is moving directly toward or away from the imager so that a minor axis of the non-spherical object is perpendicular to a line of sight to the imager, the processor is configured to determine the wobbling angle by dividing a number of pixels representing the maximum deflection of the first point through a full revolution of the non-spherical object by a number of pixels representing a width of at least one of the object portions and multiplying this value by a known extent of the minor axis of the non-spherical object.

In an embodiment, the non-spherical object is one of an American football, an Australian football, and a Rugby ball.

In an embodiment, the processor is configured to identify a second point on the non-spherical object in each of the images, the first and second points being on opposite sides of a center of mass of the non-spherical object, the processor being configured to calculate a first travel path for the first point and a second travel path for the second point and to determine the wobbling angle by as half of an angle between the first and second travel paths.

In addition, the present disclosure relates to a method for determining flight characteristics of a non-spherical object. The method includes tracking using a tracking device a non-spherical object and generating data corresponding to one of a range and a range rate of a non-spherical object as it passes through a field of view of the tracking device; generating, via an imager, a series of images of the non-spherical object as it traverses an overlap field of view in which a field of view of the imager and the field of view of the tracking device overlap; detecting by a processing arrangement the non-spherical object in each of a plurality of the images from the series of images; identifying by the processing arrangement a predetermined characteristic point on the non-spherical object in each of the images; determining by the processing arrangement a displacement of the characteristic point relative to a center of mass of the portion of the image representing the non-spherical object in each of the images; and determining by the processing arrangement based on the data from the tracking device and the displacement of the characteristic point, a wobbling angle of the non-spherical object corresponding to an angle between a plane of rotation of a major axis of the non-spherical object and a direction of travel of the non-spherical object.

In an embodiment, the direction of travel of the non-spherical object is a direction of travel of a center of mass of the non-spherical object.

In an embodiment, the method further includes determining the direction of travel of the center of mass of the non-spherical object by as a direction of travel of the centers of mass of the portions of the image representing the non-spherical object in a plurality of successive ones of the images.

Also, the present disclosure relates to a method to determine a toppling frequency of an object by generating a signal corresponding to the change of the apparent size of the ball over time. This signal is then analyzed for a time periodic behavior in the frequency of time domain. The toppling frequency is derived from the determined time period.

The preferred embodiment to determine the change in apparent size of the non-spherical ball is based on analyzing the time varying Doppler signal received by a Doppler radar from a rotating non-spherical ball during a portion of its flight. Due to rotation of the non-spherical ball the Doppler broadening bandwidth of the rotating ball will change over time. A corresponding signal over time can be generated representing the bandwidth, the upper and/or lower frequency contour. Also, the signal strength, the center Doppler frequency shift and corresponding phase information of the received signal from the rotating non-spherical sports ball will change periodically over time and can be used for generating a corresponding signal. The signal is analyzed for a time periodic behavior in either the frequency or time domain. The toppling frequency is derived from the determined time period.

In an alternative embodiment the change in apparent size of the ball over time is determined from multiple images captured by an imager and determining the size of the ball in pixels over time and generating a corresponding signal. This signal will be slowly decaying if the ball is moving away from the imager but will have a periodic oscillation corresponding to the toppling of the ball. Also, in this embodiment the signal is analyzed for a time periodic behavior in either the frequency or time domain. The toppling frequency is derived from the determined time period.

The present disclosure also relates to a system which includes a radar configured to capture radar data of a non-spherical object. In addition, the system includes a processor configured to detect, in the radar data, oscillations corresponding to rotation of the object about an axis that is not an axis of symmetry of the object and determine a frequency of the rotation of the object about the axis based on the detected oscillations.

In addition, the present disclosure relates to a method which includes generating, by an imager, a plurality of images of a non-spherical object as the object rotates about an axis that is not an axis of symmetry of the object; determining, in each of the plurality of images, a size of a portion of the image representing the object; and determining a frequency of rotation of the object about the axis based on the sizes of the portions of the images representing the object over time.

Furthermore, the present disclosure relates to a method which receiving, by a sensor, data corresponding to rotation of a non-spherical object about an axis that is not an axis of symmetry of the object; detecting, in the data, oscillations corresponding to the rotation of the object about the axis; and determining a frequency of the rotation of the object about the axis based on the detected oscillations.

In addition, the present disclosure relates to a system for determining a wobbling angle of a non-spherical object. The system comprises an imaging device having a field of view through which the non-spherical object passes, the imaging device being configured to generate a series of images of the non-spherical object; and a processor connected to the imaging device and being configured to: identify, in a first image of the images and a second image of the images, a center of mass of the non-spherical object; identify a first characteristic point on the non-spherical object in the first and second images; determine a displacement of the first characteristic point relative to the center of mass of the non-spherical object between the first and second images; and determine the wobbling angle based on the displacement of the first characteristic point.

In an embodiment, the processor is configured to identify in each image a subset of pixels representing an outline of the non-spherical object and determine the center of mass of the non-spherical object based on the outline.

In an embodiment, the processor is configured to determine a further value for the wobbling angle based on analysis of at least one further image.

In an embodiment, the processor is configured to determine an average of the wobbling angle and the further value of the wobbling angle.

In an embodiment, the processor determines the wobbling angle based on a Dense Optical Flow analysis of the first and second images.

In an embodiment, the system further comprises a tracking device sensing data corresponding to a distance to the non-spherical object, wherein the processor determines the wobbling angle based on a distance to the non-spherical object at a first time corresponding to the first image and a second time corresponding to the second image.

In an embodiment, the imaging device is positioned so that an imaging plane of the imaging device is substantially perpendicular to a plane within which the non-spherical object is expected to travel.

In an embodiment, the imaging device is positioned so that an imaging plane of the imaging device is substantially parallel to a plane within which the non-spherical object is expected to travel.

In addition, the present disclosure relates to a method for determining a wobbling angle of a non-spherical object. The method comprises generating a series of images of the non-spherical object in flight; determining, for a first image of the images, a center of mass of the non-spherical object; identifying a characteristic point on the non-spherical object in the first image and a second image of the images; determining a displacement of the characteristic point relative to the center of mass of the non-spherical object between the first and second images; and determining the wobbling angle based on the displacement of the characteristic point.

In an embodiment, the method further comprises determining a distance from an imager to the characteristic point.

In an embodiment, the method further comprises determining the wobbling angle based on the distance from the imager to the characteristic point.

In an embodiment, the method further comprises positioning an imager generating the images so that an expected path of travel of the non-spherical object is in a plane substantially perpendicular to an image plane of the imager.

In an embodiment, the method further comprises positioning an imager generating the images so that an expected path of travel of the non-spherical object is in a plane substantially parallel to an image plane of the imager.

In an embodiment, the method further comprises identifying in each image a subset of pixels representing an outline of the non-spherical object; and determining the center of mass of the non-spherical object based on the outline determined.

In an embodiment, the method further comprises determining a further value for the wobbling angle based on at least one further image.

In an embodiment, the method further comprises determining an average of the wobbling angle and the further value of the wobbling angle.

In an embodiment, the non-spherical object is one of an American football, an Australian football, and a Rugby ball.

In addition, the present disclosure relates to a system for determining a wobbling angle of a non-spherical object. The system comprises an imaging device having a field of view through which the non-spherical object is expected to travel, the imaging device being configured to generate a series of images of the non-spherical object as it travels through the field of view; and a processor connected to the imaging device and being configured to: identify a characteristic line of the spinning non-spherical object in a first image of the images and a second image of the images; determine a travelling direction of the spinning non-spherical object based on the first and second images; and determine the wobbling angle of the non-spherical object as an angle between the travelling direction and the characteristic line.

In an embodiment, the non-spherical object is a sports ball having a minor and a major axis and wherein the predetermined characteristic line is the major axis of the sports ball.

In an embodiment, the imaging device is placed so that an image plane of the imaging device is substantially orthogonal to a plane within which the non-spherical object is expected to travel.

In addition, the present disclosure relates to a method for determining a wobbling angle of a non-spherical object. The method comprises generating a series of images of the non-spherical object; identifying a characteristic line of the non-spherical object in a first image of the images and a second image of the images; determining a travelling direction of the non-spherical object based on the first and second images; and determining the wobbling angle as an angle between the travelling direction and the predetermined characteristic line of the spinning non-spherical object.

In an embodiment, the non-spherical object is a sports ball having a minor and a major axis; and wherein the characteristic line is the major axis of the sports ball.

In an embodiment, the method further comprises placing an imager generating the images so that an image plane of the imager is substantially orthogonal to a plane within which the non-spherical object is expected to travel.

In an embodiment, the method further comprises placing an imager generating the images so that an imaging plane of the imager is substantially parallel to a plane within which the non-spherical object is expected to travel.

In an embodiment, the present disclosure relates to a system for analyzing flight of a non-spherical object. The system comprises an imaging device having a field of view through which the non-spherical object is expected to pass, the imaging device being configured to generate a series of images of the non-spherical object; and a processor connected to the imaging device and being configured to: identify a center of mass of the non-spherical object in flight in a first image of the images and a second image of the images; identify a first characteristic point on the non-spherical object in the first and second images; determine a travelling path of the center of mass based on the first and second images; identify a toppling axis about which the non-spherical object is rotating based on positions of the first characteristic point relative to the center of mass in the first and second images; and determine a toppling angle as an angle between a vertical and a plane including the travelling path of the center of mass and the toppling axis.

In an embodiment, the processor is further configured to: identify in the first and second images a second characteristic point on the non-spherical object; identify a major axis of the non-spherical object based on the positions of the first and second characteristic points relative to the center of mass in the first and second images and wherein the processor is configured to determine based on positions of the major axis in the first and second images, a mirror position of the major axis in a position of the non-spherical object rotated 180 degrees about the toppling axis from the position of the major axis in the first image; and identify the toppling axis as a line bisecting an angle formed between the position of the major axis in the first image and the mirror position.

In an embodiment, the processor is further configured to: determine an offset angle as an angle between the position of the major axis in the first image and the toppling axis.

In addition, the present disclosure relates to a system for determining flight characteristics of a non-spherical object. The system comprises a tracking device generating data corresponding to one of a range and a range rate of the non-spherical object passing through a field of view of the tracking device; an imager having a field of view that at least partially overlaps with the field of view of the tracking device in an overlap field of view, the imager generating images of the non-spherical object as it traverses the overlap field of view; and a processor receiving images from the imager and the tracking device, the processor being configured to detect the non-spherical object in each of a plurality of the images and to detect a center of mass of object portions of each of the images, wherein the object portion of each of the images is a portion of each image showing the non-spherical object, the processor being configured to identify the center of mass of each of the object portions and to identify a first point on the non-spherical object in each of the object portions, the processor determining a displacement of the first point relative to the center of mass between a first one and a second one of the object portions, the processor determining, based on the data from the tracking device and the displacement of the first point, a wobbling angle of the non-spherical object corresponding to an angle between a plane of rotation of a major axis of the non-spherical object and a travel direction along which the center of mass of the non-spherical object is moving.

In an embodiment, the processor is configured to identify the object portion of each image by identifying a subset of pixels representing an outline of the non-spherical object, the processor identifying the center of mass each of the object portions based on the outline.

In an embodiment, the processor is configured to determine an average value for the wobbling angle through a portion of movement of the non-spherical object represented by the images.

In an embodiment, the processor is further configured to: determine a distance from the imager to the first point on the non-spherical object; and determine the wobbling angle based on the displacement of the first point and the distance from the imager to the first point.

In an embodiment, when the non-spherical object is moving directly toward or away from the imager so that a minor axis of the non-spherical object is perpendicular to a line of sight to the imager, the processor is configured to determine the wobbling angle by dividing a number of pixels representing a maximum deflection of the first point through a full revolution of the non-spherical object by a number of pixels representing a width of at least one of the object portions and multiplying this value by a known extent of the minor axis of the non-spherical object.

In an embodiment, the non-spherical object is one of an American football, an Australian football, and a Rugby ball.

In an embodiment, the processor is configured to identify a second point on the non-spherical object in each of the images, the first and second points being on opposite sides of a center of mass of the non-spherical object, the processor being configured to calculate a first travel path for the first point and a second travel path for the second point and to determine the wobbling angle by as half of an angle between the first and second travel paths.

In an embodiment, the processor is configured to construct a composite image including at least first and second object portions, the composite image being generated so that the center of mass of each of the first and second object portions is located at the same position in the composite image.

In addition, the present disclosure relates to a method for determining flight characteristics of a non-spherical object. The method comprises tracking using a tracking device the non-spherical object and generating data corresponding to one of a range and a range rate of the non-spherical object as it passes through a field of view of the tracking device; generating, via an imager, a series of images of the non-spherical object as it traverses an overlap field of view in which a field of view of the imager and the field of view of the tracking device overlap; detecting by a processing arrangement the non-spherical object in each of a plurality of the images from the series of images; identifying by the processing arrangement a predetermined characteristic point on the non-spherical object in each of the images; determining by the processing arrangement a displacement of the characteristic point relative to a center of mass of a portion of the image representing the non-spherical object in each of the images; and determining by the processing arrangement based on the data from the tracking device and the displacement of the characteristic point, a wobbling angle of the non-spherical object corresponding to an angle between a plane of rotation of a major axis of the non-spherical object and a direction of travel of the non-spherical object.

In an embodiment, the direction of travel of the non-spherical object is a direction of travel of a center of mass of the non-spherical object.

In an embodiment, the method further comprises determining the direction of travel of the center of mass of the non-spherical object by as a direction of travel of the centers of mass of the portions of the image representing the non-spherical object in a plurality of successive ones of the images.

In addition, the present disclosure relates to a system for analyzing a toppling of a non-spherical object. The system comprises an imager positioned to view a toppling non-spherical object such that an image plane of the imager is substantially perpendicular to a path of movement of the toppling non-spherical object; and a processor configured to analyze images from the imager, the processor identifying in a plurality of images from imager object portions including a first object portion in a first image of the images and a second object portion in a second image of the images, wherein the object portions are a portion of each image representing the non-spherical object, the processor being configured to identify a first characteristic point on the non-spherical object in each of the first and second images and to determine a displacement of the first characteristic point between the first and second images, the processor determining, based on one of a priori knowledge of dimensions of the non-spherical object and a displacement of a second characteristic point on the non-spherical object identified in each of a third image of the images and a fourth image of the images, an offset angle between a path of motion of a major axis of the non-spherical object and a toppling plane.

In an embodiment, each of the first and second characteristic points is an end of the non-spherical object wherein the processor is configured to determine the offset angle based on a comparison of the positions of the first and second characteristic points at positions of the non-spherical object in the first and second images wherein the first image represents the non-spherical object rotated by 180 degrees as compared to the second image.

In an embodiment, the processor is configured to identify a center of mass of each of the first and second object portions and wherein the processor determines the displacement of the first characteristic point between the first and second images relative to the center of mass.

In an embodiment, the processor determines the displacement of the second characteristic point from the third image to the fourth image relative to the center of mass.

In an embodiment, the processor determines the offset angle as half of an angle between the major axes in the first and second images.

In an embodiment, the non-spherical object is an American football and the a priori knowledge includes a length of a major axis and a minor axis of the American football.

In an embodiment, the processor is further configured to: determine a toppling angle of the non-spherical object as an angle between the toppling plane and a vertical.

### BRIEF DESCRIPTION

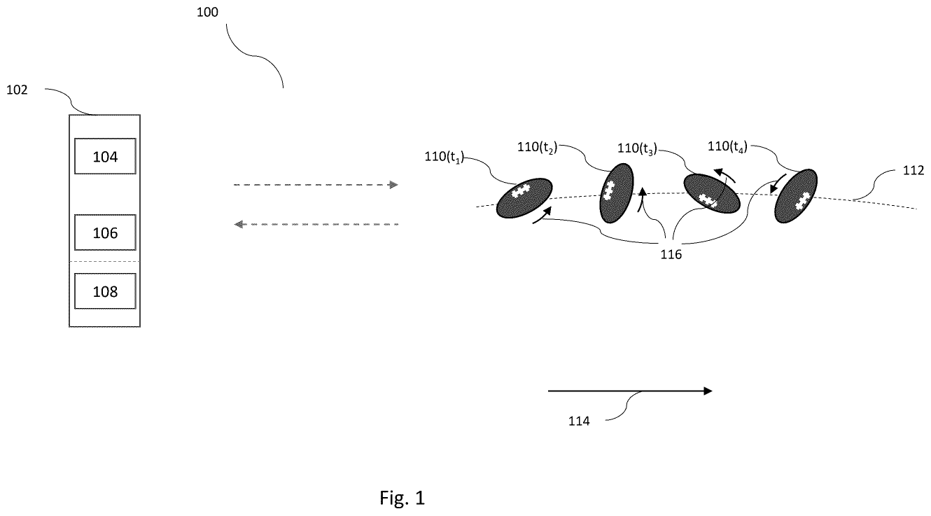

FIG. 1 shows a radar system for determining a toppling frequency of a rotating spheroid ball according to a first exemplary embodiment of the present disclosure.

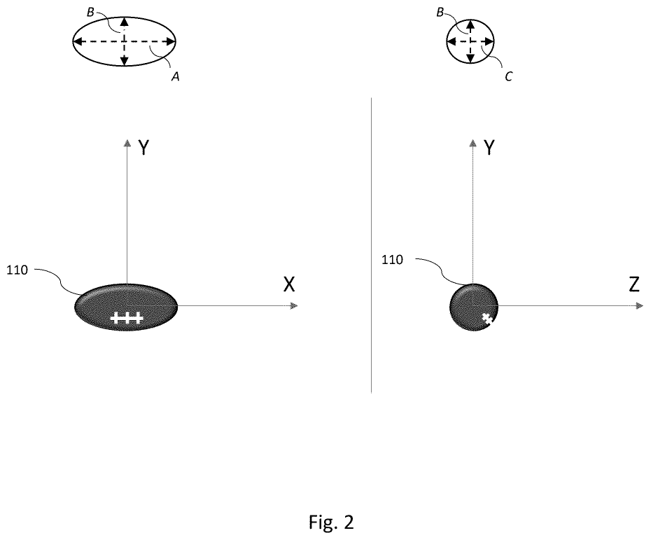

FIG. 2 shows the rotating spheroid ball of the exemplary system of FIG. 1.

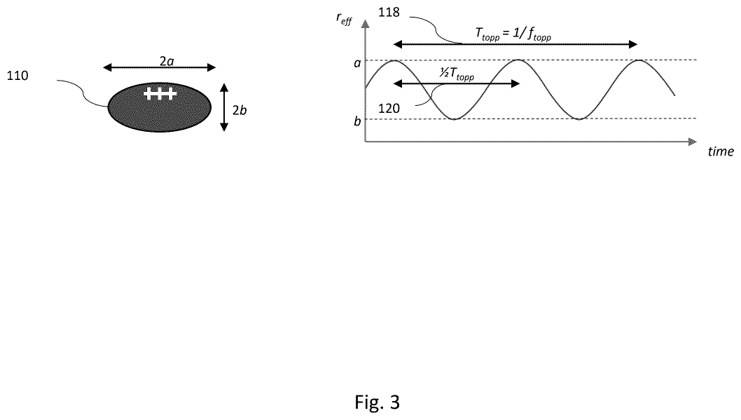

FIG. 3 shows a graph illustrating a change in an effective radius of the rotating spheroid ball of the exemplary system of FIG. 1, relative to the receiver of the radar device.

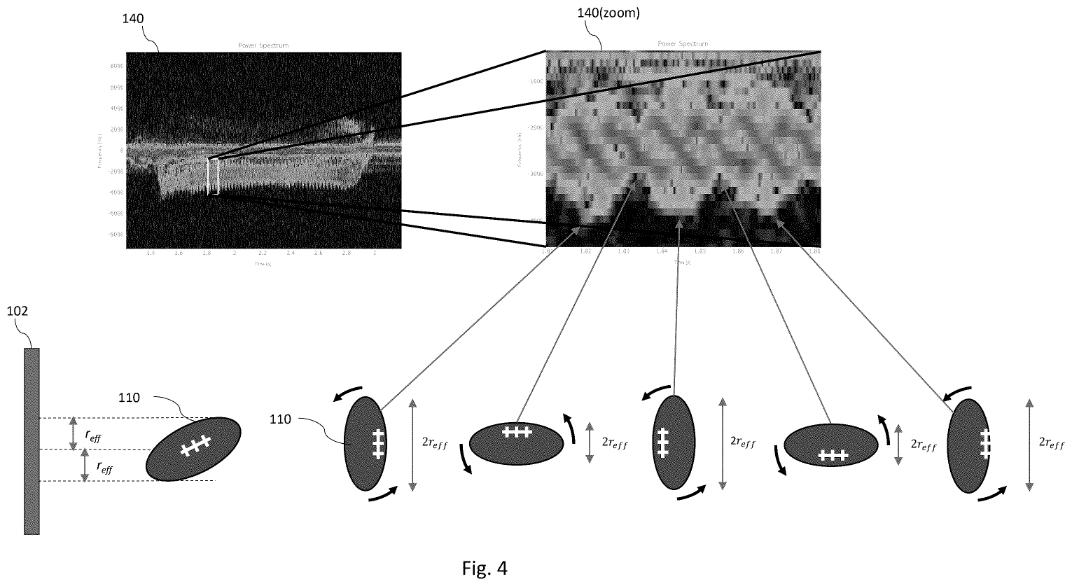

FIG. 4 shows a frequency analysis of a Doppler signal received from a toppling spheroid ball according to the first exemplary embodiment of the present disclosure.

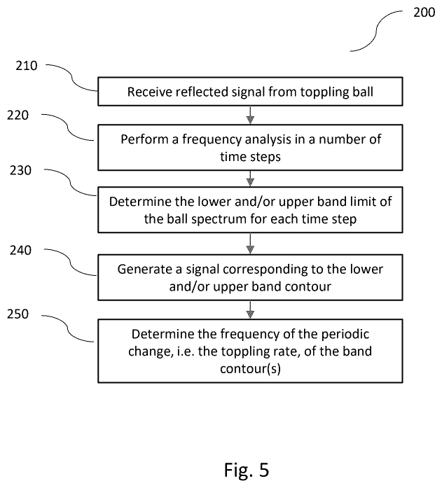

FIG. 5 shows a method for determining a toppling frequency of a rotating spheroid ball according to the first exemplary embodiment of the present disclosure.

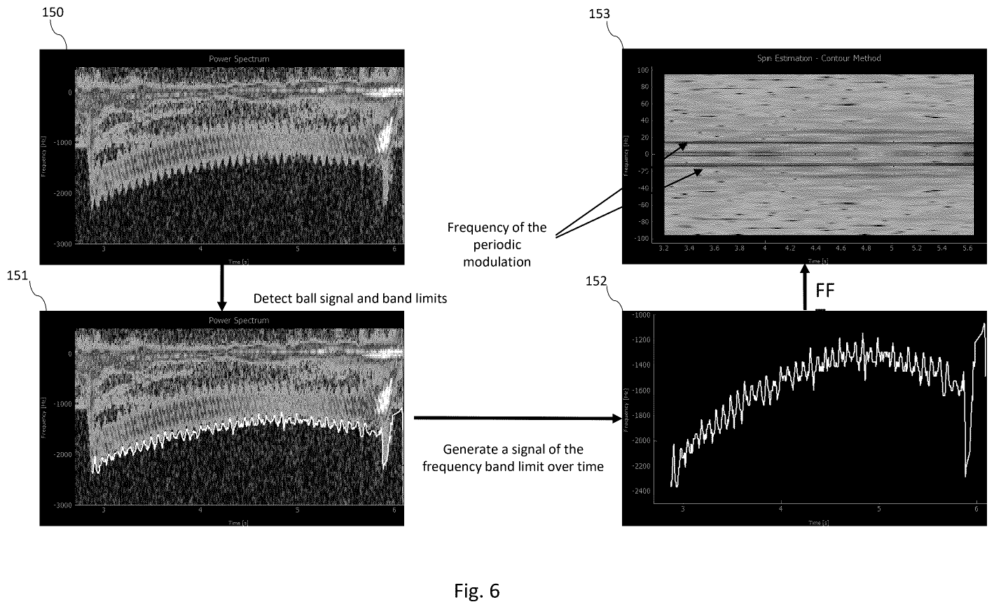

FIG. 6 shows a graphical illustration of certain steps of the method of FIG. 5.

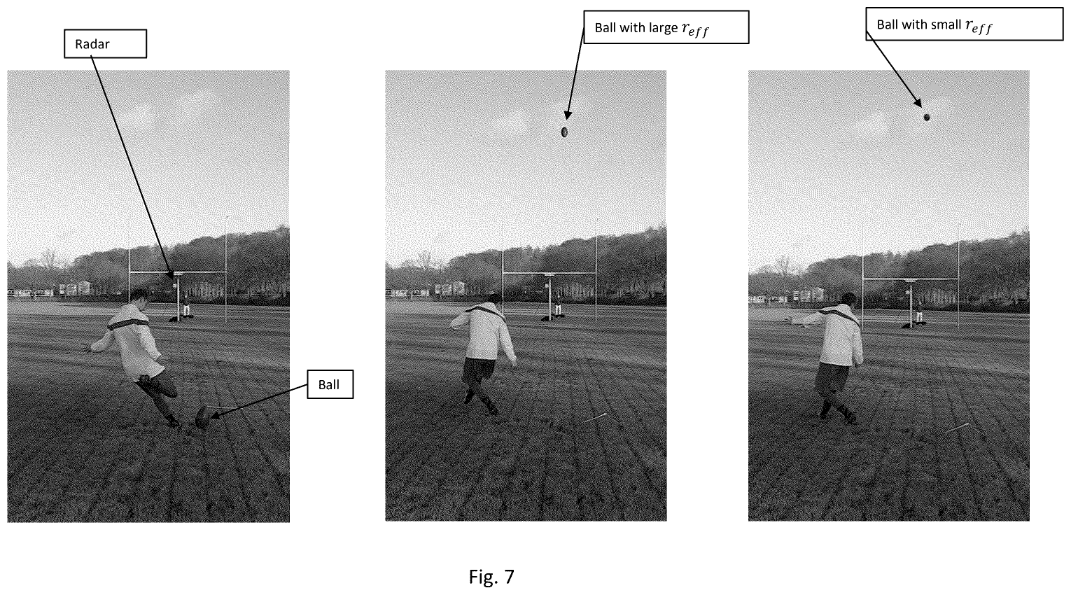

FIG. 7 shows an exemplary radar setup for determining a toppling frequency of a rotating spheroid ball according to an exemplary embodiment of the present disclosure.

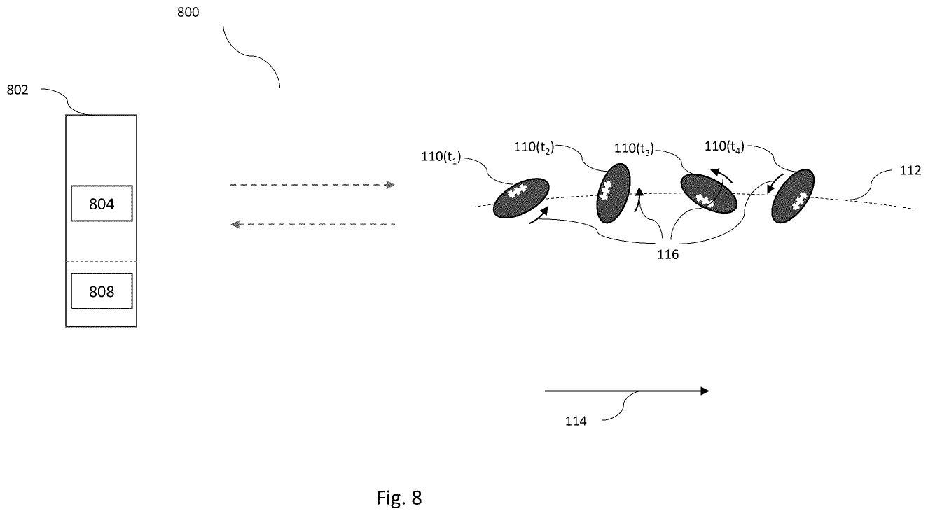

FIG. 8 shows an imaging system for determining a toppling frequency of a rotating spheroid ball according to a second exemplary embodiment of the present disclosure.

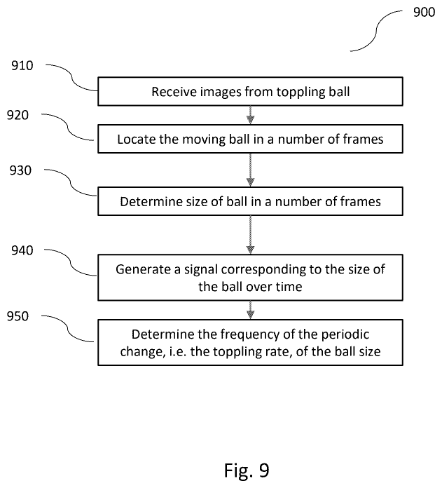

FIG. 9 shows a method for determining a toppling frequency of a rotating spheroid ball according to the second exemplary embodiment of the present disclosure.

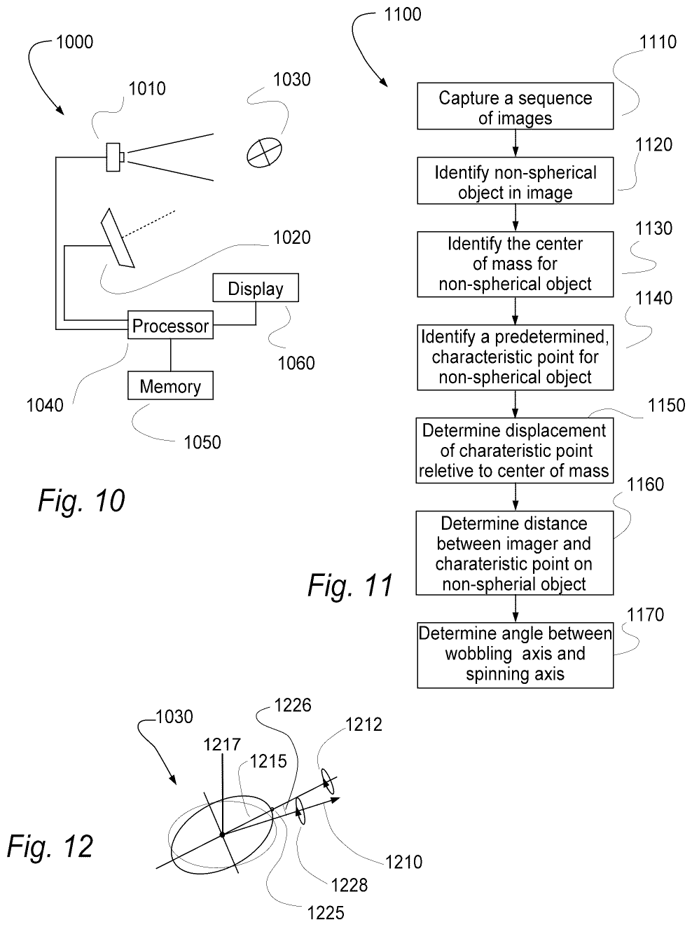

FIG. 10 shows an exemplary embodiment of a system for determining the behavior of the non-spherical ball in flight.

FIG. 11 shows a flow chart for determining the wobbling angle of the non-spherical ball.

FIG. 12 shows an outline image with outlines of the non-spherical ball are overlaid with coinciding centers.

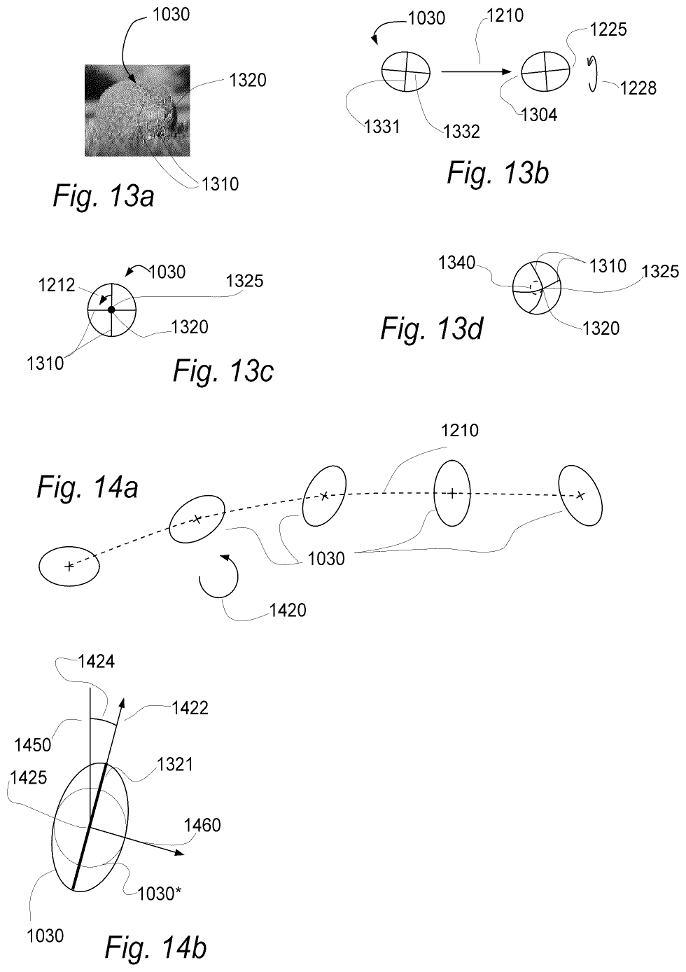

FIG. 13a shows an example of an American football.

FIG. 13b-d shows a wobbling ball in flight.

FIG. 14a shows the flight of a kicked toppling ball in flight.

FIG. 14b shows the toppling ball in flight captured by an imager positioned behind the kicking football player.

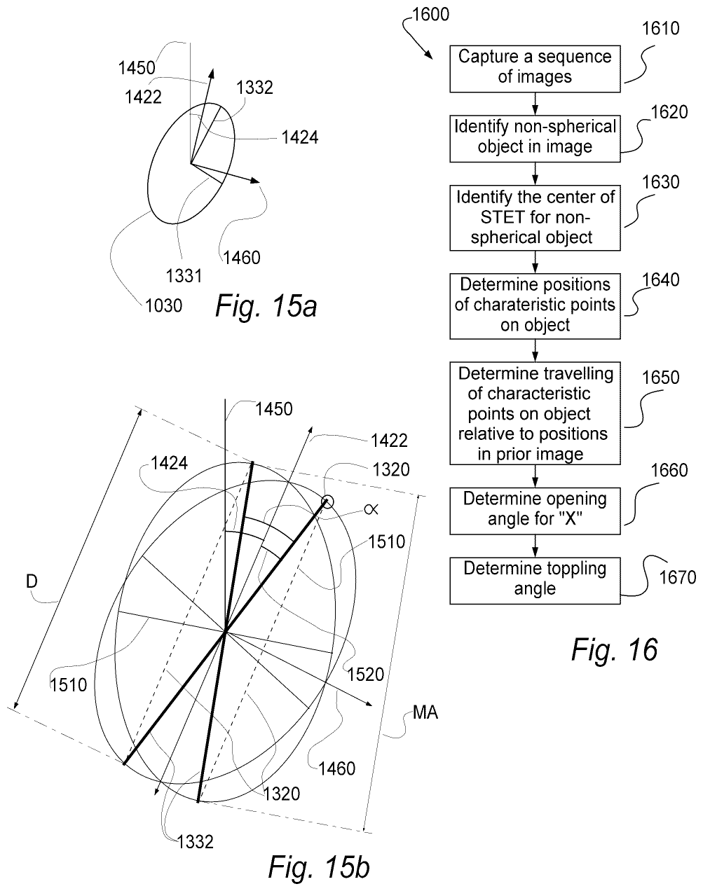

FIG. 15a shows a toppling ball in flight captured by an imager positioned behind the kicking football player.

FIG. 15b shows the toppling ball shown in FIG. 15a with an indication of the travelling of the two crossings of the sewing on the ball.

FIG. 15c shows a geometric plan of the “X” and the major axis as well as the lines marking the paths of the ends of the football of FIGS. 15a and 15b.

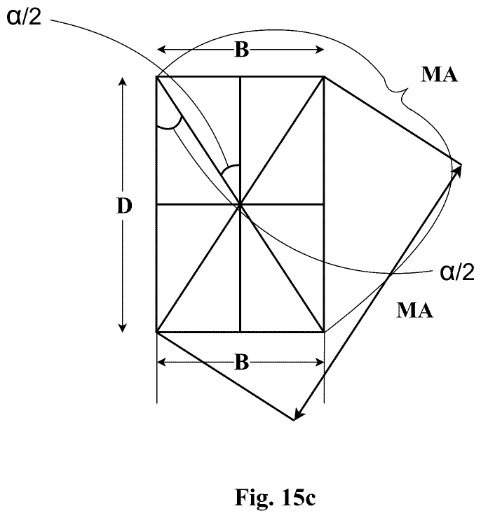

FIG. 16 illustrates a flow chart for determining the toppling axis and toppling axis of the non-spherical ball.

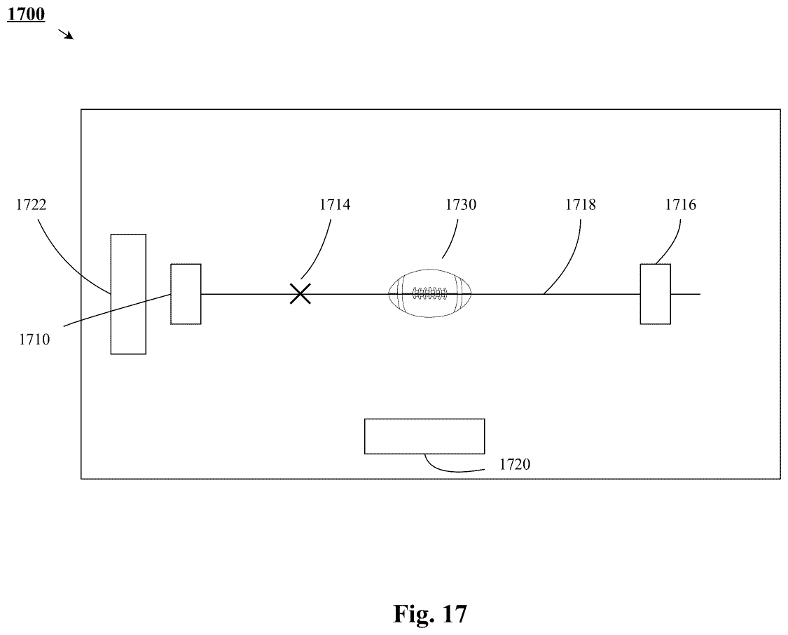

FIG. 17 shows another exemplary embodiment of a system according to the present disclosure designed for use in non-game situations.

### DETAILED DESCRIPTION

The exemplary embodiments may be further understood with reference to the following description and the related appended drawings, wherein like elements are provided with the same reference numerals. The exemplary embodiments relate to a system and method for measuring a toppling frequency of a moving non-spherical sports ball while in flight. In the following, sports balls are divided into two general types of sports ball shapes; the spherical ball (e.g., golf ball, football (soccer ball), tennis ball, baseball, etc.) and the non-spherical, typically ellipsoid-like-shaped ball, otherwise known as a spheroid ball (e.g., American football, Australian football, rugby ball, etc.). Small modifications to the ball such as the seams on a baseball and the dimples on a golf ball that cause these generally spherical balls to deviate from a perfect sphere are not considered to substantially affect the general overall shape of the balls, which are still considered spherical for the purposes of this analysis. We will also in the following restrict ourselves to the discussion of oblate spheroids and prolate spheroids, i.e., spheroids comprising three orthogonal symmetry axes where two of the three axes, B and C, are of equal length (2b and 2c respectively), and the third axis, A, is either shorter or longer (with length 2a) respectively, than the other two.

An American football is an example of a prolate spheroid. This restriction should not be seen as a limitation of the exemplary embodiments but should rather serve as a way to more easily illustrate the current disclosure. While most sports balls may be described by these two shapes, the following disclosure should not be viewed as a limitation of the current disclosure to cover only these types of balls, but rather should serve as an illustration of the practical application of the current disclosure to these types of balls. Although exemplary embodiments detailed herein describe the tracking of American footballs, those skilled in the art will understand that any non-spherical sports ball or even non-sports related non-spherical objects may be tracked in the same manner.

A spheroid ball, e.g., an American football, has two independent types of rotation. These two types of rotation may be denoted as “spin” and “toppling.” Spin is defined as rotation of the spheroid ball about the symmetrical axis, A, which passes through the center of mass of the ball and leaves the apparent orientation of the ball substantially unchanged as the ball spins. In practice, features such as seams and laces on an otherwise spheroid football will cause the center of mass of the football to lie at a point that is slightly off of an axis of geometric symmetry. Thus, the symmetrical axis of the football may not be perfectly coincident with the spin axis of the football.

However, this is generally relevant only to a rifle spin (or spiral) and does not significantly impact the analysis of the type of end over end toppling about an axis other than the spin axis passing through the center of mass addressed in this application. In FIG. 2, for example, this spin axis of the spheroid ball 110 is its X-axis. For a spherical ball, e.g., a golf ball, the spin axis is not restricted to a specific orientation of the ball. The apparent orientation of a spherical ball remains the same regardless of the axis about which it is rotating. Various methods for the determination of a spin frequency for a spherical ball, i.e., a frequency of rotation about the spin axis, are known in the prior art (see, e.g., U.S. Pat. No. 8,845,442B2) and will not be discussed in further detail here.

Toppling is defined as the rotation of the ball about any axis that is not the spin axis. This axis is referred to herein as the toppling axis. In situations where the ball experiences rotation only about the A-axis, i.e., the spin axis, it may be considered that the ball is unaffected by toppling, i.e., it does not topple. In the case of the spheroid ball 110 illustrated in FIG. 2, toppling is the rotation of the A-axis of the spheroid ball 110 about a toppling axis, which can take any orientation. A toppling frequency, or toppling rate, of a ball may be defined as a frequency of a rotation of the ball about the toppling axis. The present disclosure is directed to a novel method for determining the toppling frequency of a non-spherical ball. Toppling is a feature unique to non-spherical balls, considering spherical balls have a uniform orientation with respect to the shape of the ball.

Furthermore, toppling may sometimes be referred to as tumbling with the distinction that tumbling may be used to refer to rotation of the ball about any axis that is not the spin axis (e.g., the major axis) while toppling is sometimes used to refer to as a special case of tumbling about an axis that is perpendicular to the plane in which the major axis rotates (perfect end over end rotation where the toppling axis is coincident with the minor axis of the ball). In this application, toppling will be used to refer to rotation of a non-spherical ball about any axis that is not the spin axis (e.g., any axis that is not the major axis of the ball). The offset angle as that term is used in this application will refer to the angle between the major axis of the ball and a plane within which the ball topples. This plane will pass through the center of gravity of the ball and, as will be described in more detail later, will be parallel to and midway between two planes each of which is defined by one of the ends of the ball as the end rotates during toppling. This offset angle indicates a difference between the present ball movement and perfect end-over-end toppling. In addition, a toppling angle will be determined that indicates an offset of the toppling plane relative to the vertical.

FIG. 1 shows an exemplary embodiment according to the present disclosure of a radar system 100 for determining a toppling frequency of a rotating spheroid ball 110 according to a first exemplary embodiment of the present disclosure. The system 100 includes a radar device 102 (e.g., a Doppler radar) aimed in a direction 114 encompassing in its field of view an area into which a spheroid ball 110 is to be projected toward during at least a part of its flight along a flight path 112. The direction 114 may be toward a target area at which the spheroid ball 110 is being aimed. The radar device 102, in this exemplary embodiment, includes a single transmitter 104 and a single receiver 106. However, the radar device 102 may comprise multiple transmitters and multiple receivers for increasing the accuracy of the toppling frequency determination. The radar device 102 further includes a processor 108 which may be an integral part of the radar system or may be a separate processor connected to the radar device 102 via, for example, a wired or wireless connection, as would be understood by those skilled in the art. In a further embodiment, the processor 108 may include a computer associated with the radar device 102.

The radar device 102 may be, for example, a continuous wave (CW) Doppler radar emitting microwaves at an X-band frequency (10 GHZ) at a power of up to 500 milliWatts EIRP (Equivalent Isotropic Radiated Power), thus being compliant with FCC and CE regulations for short range international radiators. However, in other jurisdictions, other power levels and frequencies may be used in compliance with local regulations. In an exemplary embodiment, microwaves are emitted at a higher frequency between, for example, 5-125 GHZ. For more precise measurements at lower object speeds frequencies of 20 GHz or higher may be used. Any type of CW Doppler radar may be used, including phase or frequency modulated CW radar, multi frequency CW radar or a single frequency CW radar.

It will be understood that other tracking devices such as lidar may be used with radiation in either the visible or non-visible frequency region. Current pulsed radar systems are limited in their ability to track objects close to the radar device. However, the distance an object must be from these pulsed radar systems to be successfully tracked has decreased over time and is expected to continue to decrease. Thus, these types of radar may soon be effective for these operations and their use in the systems of the disclosure described below is contemplated. Throughout the application, the tracking of objects is described based on the use of Doppler frequency spectrums. As would be understood by a person skilled in the art, these Doppler frequency spectrums refer to the data from CW Doppler radar. If a pulse-Doppler radar is used a similar Doppler frequency spectrum can be generated and similar method applied. Any other type of radar or lidar capable of generating a Doppler frequency spectrum may also be used.

In the embodiment of FIG. 1, the system 100 is a radar system for determining a toppling frequency of a rotating spheroid ball 110, e.g., an American football, projected from a launch position toward a target area. The spheroid ball may be thrown, kicked, or otherwise launched from the launch position. As is understood by those skilled in the art, the target area does not need to be any specially created area, and the launch position may be any location within or outside the field of view of the radar device 102. FIG. 1 shows an orientation of the spheroid ball 110 at four non-overlapping times, t₁, t₂, t₃, and t₄, as the spheroid ball 110 travels in a translational velocity direction 114.

As is clear in FIG. 1, the spheroid ball 110 is rotating in a direction 116 about an axis that is not parallel to the major A-axis of the spheroid ball 110, i.e., the X-axis shown in FIG. 2. The radar device 102 tracks the spheroid ball 110 as it is launched from the launch location (if the launch location is within the field of view of the radar device 102) or when the spheroid ball 110 enters the field of view of the radar device 102 and travels along the flight path 112. As the spheroid ball 110 moves, radar waves transmitted by the transmitter 104 of the radar device 102 are reflected from the spheroid ball 110 and are received by the receiver 106 of the radar device 102. As understood by those skilled in the art, a Doppler radar transmits a radar wave, receives a reflected radar wave, and measures a frequency of the reflected wave. The difference between the frequency of the reflected wave and a frequency of the transmitted wave is called a Doppler shift. The Doppler shift is proportional to the velocity of the reflected object relative to the radar.

When the spheroid ball 110 is affected by toppling, different parts of the spheroid ball 110 will have different speeds relative to the radar, causing a Doppler broadening of the reflected signal from the spheroid ball 110. That is, a range of frequency differences will be detected as the velocity of different portions of the spheroid ball 110 relative to the radar will vary as some parts of the spheroid ball 110 spin toward the radar (reducing the relative velocity and, consequently, the frequency difference) while other portions of the spheroid ball 110 spin away from the radar. The bandwidth of the Doppler broadening is proportional to a rate of rotation and an effective radius, r_{eff}, of the spheroid ball 110 at a given point in time, where the effective radius, r_{eff}, is defined as a maximum distance of the rotating ball from the center of the rotation as seen from the radar. In other words, r_{eff} is the maximum distance of the rotating ball from the center of the ball relative to the line of sight of the radar to the ball, i.e., projected into a plane perpendicular to the line of sight from the radar to the ball.

FIG. 3 shows a graph illustrating a change in an effective radius of the rotating spheroid ball 110 of the system 100 of FIG. 1, relative to the receiver 106 of the radar device 102. As may be seen in FIG. 3, a first semi-radius of the spheroid ball 110 may be defined as “a” and a second semi-radius of the spheroid ball 110 may be defined as “b,” with corresponding semi-diameters having lengths of 2a and 2b. For a toppling ball, the effective radius changes periodically. A toppling period 118, Tₜₒₚₚ, may be defined as a time required for a full revolution of the spheroid ball 110 about the toppling axis. The toppling period 118 is shown as two half-waves of period 120 in the graph of FIG. 3, as the spheroid ball 110 appears the same size for every half revolution of the ball around the toppling axis.

FIG. 4 shows a frequency analysis of a Doppler signal received from a toppling spheroid ball 110 according to an exemplary embodiment of the present disclosure. Different stages of the toppling rotation are assigned to different parts of a spectrogram 140 obtained from the frequency analysis. The spectrogram consists of multiple STFTs (Short Time Fourier Transformations) adjacent in time, with the x-axis being time and the y-axis being the frequency. As discussed previously, the radar device 102 transmits waves from the transmitter 104 and receives waves reflected from the spheroid ball 110 in the receiver 106, generating a corresponding signal of the toppling spheroid ball 110.

Although the exemplary embodiments are described with respect to a spheroid shape, the systems and methods of these embodiments may track any non-spherical shape, or any object including an irregularity that causes the apparent size of the object, as seen from the radar, to change over the course of a rotation. The toppling of the spheroid ball 110 causes a periodic modulation of the bandwidth of the received signal, as shown in the zoomed spectrogram 140. For example, an upright orientation of the spheroid ball 110 corresponds to a frequency response more negative than a lateral orientation of the spheroid ball 110, as shown in FIG. 4. The spheroid ball 110 may also be spinning, causing an additional modulation of the signal. However, the exemplary embodiments may be performed whether or not an additional spin is present on the spheroid ball 110.

A maximum velocity seen by the radar due to toppling relative to the velocity of the center of the ball is given by: Vᵣₘₐₓ=r_{eff}·ωₜₒₚₚ. This maximum velocity corresponds to maximum Doppler shift of: fₘₐₓ=2·Vᵣₘₐₓ/λ=2·r_{eff}/λ·ωₜₒₚₚ. Since this is a frequency modulated signal, the Carson bandwidth rule states that the ball signal has 98% of its power contained within the bandwidth, BW, given by:

$$B W = 2 \cdot ( \frac{2 \cdot {r}_{eff}}{λ} + \frac{1}{2 π} ) \cdot {ω}_{topp}$$

where ωₜₒₚₚ=2π·fₜₒₚₚ is the angular frequency corresponding to the toppling rate fₜₒₚₚ, λ is the wavelength of the transmitted radar waves and r_{eff} is the effective radius of the ball as seen from the radar. As the effective radius of the ball changes during ball flight due to the toppling of the ball, the bandwidth undergoes a similar periodic change with a frequency equal to that of twice the toppling rate fₜₒₚₚ. Since r_{eff} changes over time, so will the bandwidth BW and the maximum Doppler shift fₘₐₓ change over time. So, by detecting the frequency or time period for changes in the bandwidth BW or maximum Doppler shift fₘₐₓ over time, the toppling frequency can be determined.

The periodic modulation caused by toppling may be detected by only a single radar with a single receiver antenna. However, multiple radars and/or multiple receiver antennas may be added for increased accuracy. The toppling rate of the ball will be equal to half the frequency of the periodic modulation in the signal, as illustrated in FIG. 4, since the spheroid ball will appear to be the same size for every half a revolution of the ball about the toppling axis. FIG. 7 shows an exemplary radar setup for determining a toppling frequency of a rotating spheroid ball according to an exemplary embodiment of the present disclosure. The system of FIG. 7 includes a single radar setup, positioned facing the launch area and separated from the launch area in a target area toward which the ball is to be launched. However, the radar may be disposed in any position (e.g., on the side of a football field rather than only at the front or back of the football field). The only positional limitation is a rare scenario where the line of sight of the radar is parallel with the toppling axis of a launched football, in which case the radar would not register the periodic oscillations caused by the toppling. However, even when the toppling axis of the football coincides with the line of sight of the radar at a given point during a flight, it is a near certainty that at other points during the flight the line of sight and the toppling axis will not coincide, and the radar data will register the periodic oscillations caused by the toppling.

FIG. 5 shows a method 200 for determining a toppling frequency of a rotating spheroid ball 110 according to an exemplary embodiment of the present disclosure.

In 210, the radar device 102 receives reflected radar waves, in whole or in part from a toppling object. The ball has a non-spherical shape or other irregularity causing the size of ball (from the perspective of the radar device 102) to change as the orientation of the ball relative to the radar device 102 changes as the ball topples. The received signal, showing a frequency response over time, such as that shown in 150 of FIG. 6, is generated from radar waves reflected from the ball and received at the receiver 106 of the radar device 102. The received signal may be seen in 150 to be periodically “envelope”-modulated with an upper bound contour, fᵤₚ, and a lower bound contour, f_{low}, of the bandwidth of the signal. The frequency band limit is then Fourier transformed to determine a frequency of the periodic modulation of the received signal as seen in the box 153 as will be described in more detail below.

In 220, a frequency analysis is performed on the received signal in a number of time steps. The distance between each of the time steps, according to the Nyquist sampling theorem, should preferably be less than half of a period Tₘᵢₙ of a maximum expected toppling frequency f_{topp,max}, wherein f_{topp,max}=1/Tₘᵢₙ. The frequency analysis may be carried out using, e.g., a short-time Fourier transform (STFT), however other frequency analysis may be performed to identify a signal corresponding to the toppling object in either the frequency or time domain. The time span for each STFT should preferably be chosen as shorter than the period Tₘᵢₙ to avoid smearing out the time variation of the frequency bandwidth.

In 230, for each time step, the upper fᵤₚ and/or lower f_{low} frequency band limit of the spectrum corresponding to the toppling rotation of the spheroid ball 110 is determined. The determination of the frequency band limits may be done in various ways. In one embodiment, a power threshold above the noise floor in each frequency spectrum is defined, and the frequency at which the signal of the toppling ball first reaches below this threshold relative to the center of said signal is determined as the frequency band limit. Graph 151 of FIG. 6 shows a spectrogram of the frequency analysis with the lower frequency band limit f_{low} identified.

Many things may be done to make the frequency band limits as robust as possible, such as filtering or smoothing the spectrum before the detection is performed, as is known to those skilled in the art. In addition, an adaptive threshold, considering the maximum and/or average signal from the ball and the apparent noise floor, will ensure a more robust detection of either upper fᵤₚ and/or lower f_{low} frequency band limit.

In some cases, either the upper frequency band limit or the lower frequency band limit may be difficult to detect due to other interfering signals. For example, if the method is being performed during an American football game, an interfering signal may be generated by players running on the field or by other sources. In this case, only one of the two frequency band limits may be used. In an alternative embodiment, rather than determining the upper and/or lower frequency band limits per time step, other features of the periodic signal generated from the toppling rotating ball may be used. For example, an energy of the frequency band or a power at the center ball signal trace may be detected. In the following, only the upper and lower frequency band limit embodiment is explained in detail, however the determination may utilize other metrics such as ball center power P(t), energy E(t) or other signal properties.

In 240, either a corresponding signal fᵤₚ (t) and/or f_{low} (t) is generated from the detected upper fᵤₚ and/or lower f_{low} frequency band limit for each time step tᵢ, as shown in 152 of FIG. 6.

In 250, a second frequency analysis is performed on the signal(s) fᵤₚ (t) and/or f_{low}(t) and/or BW(t) to determine the periodic modulation of the signal(s), as shown in 153 of FIG. 6.

The frequency analysis may be done by, e.g., performing a second STFT on the signal(s). The time periods for the second STFT(s) may be an entire signal span of the band limit(s). Alternatively, multiple STFTs may be used for a given one of the signals, each STFT spanning a time period sufficiently long to enable a determination of the toppling rate with sufficient accuracy, as illustrated in FIG. 6. A time span shorter than the entire available signal may be preferred, since the toppling rate may change over time due to air resistance. Obviously, one can take into account a predetermined change in toppling frequency over time whereby longer time spans are possible, ultimately using the entire available signal for one STFT.

The second frequency analysis provides a frequency of the periodic change, or period of modulation corresponding to the toppling rate, in the band contour(s). Other means exist for determining a period of modulation corresponding to the toppling rate from the corresponding signal(s) (like fᵤₚ (t), f_{low}(t), BW(t), S(t)). For example, one alternative method comprises performing an autocorrelation in the time domain and detecting correlation peaks, and other standard methods exist for determining the major frequency components in a time signal, as is known by a person skilled in the art. Knowledge about an expected toppling rate may be used to improve the likelihood of identifying the correct toppling frequency. The expected toppling rate may be predetermined or derived from other measurements such as ball speed, trajectory, etc.

In a second exemplary embodiment, an imager is used instead of a radar or lidar. FIG. 8 shows an imaging system 800 for determining a toppling frequency of a rotating spheroid ball 110 according to a second exemplary embodiment of the present disclosure. The imaging system 800 includes an imaging device 802 aimed in a direction 114 encompassing in its field of view an area into which a spheroid ball 110 is to be projected toward during at least a part of its flight along a flight path 112. The direction 114 may be toward a target area at which the spheroid ball 110 is being aimed. The imaging device 802, in this exemplary embodiment, includes a single camera 804. However, the imaging device 802 may comprise multiple cameras for increasing the accuracy of the toppling frequency determination. Further cameras may be an integral part of the imaging system 800 or may be disposed at remote vantage points. The imaging device 802 further includes a processor 808 which may be an integral part of the imaging system or may be a separate processor connected to the imaging device 802 via, for example, a wired or wireless connection, as would be understood by those skilled in the art. In a further embodiment, the processor 808 may include a computer associated with the imaging device 802.

FIG. 9 shows a method 900 for determining a toppling frequency of a rotating spheroid ball according to the second exemplary embodiment of the present disclosure. Whereas in the first embodiment a periodically modulating signal is generated from Doppler frequency data, in the second embodiment a periodically modulating signal is generated from data corresponding to the size in images of the rotating ball.

In 910, the imaging device 802 captures a plurality of frames including a toppling object, e.g., the spheroid ball 110. In 920, the spheroid ball 110 is located in the plurality of frames. To identify the launched ball, the computer may first remove background elements from the captured frames (i.e., elements that are not moving from frame to frame) and look only at changes between successive frames, i.e., motion. The computer may then analyze the shapes of the moving image elements to identify a ball. There may be multiple moving objects in the images other than the ball, e.g., players, spectators, trees, etc. The computer may, for example, have a predefined ball shape and size stored in a memory with which it may identify the ball in the images.

In 930, a size of the spheroid ball 110 is determined for each of the frames. The size may be measured in various ways known in the art, e.g., determining a number of pixels included in the image of the ball. In 940, a signal representing the apparent size of the ball over time, as measured in the frames, is generated by the processor 808. The generated signal S(t) representing the size of the ball in the images over time will have a periodic component corresponding to the toppling frequency. As long as the frame rate of the imager and the ball size determination occurs according to the Nyquist criteria of at least twice for every half of the toppling frequency (i.e., a frame rate and size detection occurring at least as often as the toppling frequency), a reliable determination of the toppling frequency may be made.

In 950, a frequency analysis is done by performing a STFT on the signal S(t), i.e., the apparent size of the ball in the images over time is analyzed to determine the periodic modulation of the signal. Step 950 may be substantially similar to step 550 of method 500. As mentioned for the first embodiment, the second frequency analysis might be performed in either the frequency domain or time domain, such as performing an autocorrelation of the time signal S(t).

The methods and signals described above can of course be combined, whereby a more accurate and robust determination can be achieved, but this is not required. For example, the signal from a pulse type radar or lidar may be used to generate a signal corresponding to a change in the apparent size of the non-spherical ball. In this example, the signal strength, center Doppler frequency shift and/or corresponding phase information of the received signal is used to generate the signal corresponding to the change in the apparent size of the non-spherical ball.

The methods described above can be used to determine data related to toppling alone or may be implemented in a system capable of determining other relevant parameters such as ball speed, launch angle, etc. to gain additional insight into the ball flight. Any such system will also be able to output the toppling rate, which could be used but is not limited to usage in data visualization such as on a mobile application or in a television broadcast.

FIG. 10 shows an exemplary embodiment for a system 1000 according to the present disclosure. The system 1000 is for determining the behavior of a non-spherical ball in flight. The system 1000 comprises an imaging system 1010, e.g., corresponding to the imaging system 800. In one embodiment, the imaging system 1010 includes a single imager comprising a high-speed camera outputting, for example, 60-1000 frames per second (fps) to track a non-spherical object 1030 (e.g., an ellipsoid object such as an American football). Those skilled in the art will understand that, although the examples herein describe the non-spherical object 1030 as an American football, the systems and methods described will work equally well in analyzing the flight of thrown or kicked balls such as a rugby ball or an Australian football. The major axis 1332 and the minor axis 1331 of the non-spherical object 1030 are indicated in FIG. 13b.

The system 1000 further comprises a radar sensor for tracking the flight of a sports ball, in this embodiment including a radar 1020 configured to generate signals corresponding to at least one of a range and a range rate of the non-spherical object 1030 relative to the radar 1020. In one exemplary embodiment, the radar 1020 comprises a CW Doppler radar emitting microwaves at an X-band frequency (10 GHZ) or a K-band frequency (24 GHZ). However, those skilled in the art will understand that other types of sports ball tracking devices capable of generating data corresponding to any or all of a distance, velocity and position of a sports ball (e.g., visual tracking devices, lidar based systems, etc.) other types of radar and/or radar employing other frequency bands, etc. may be used as desired. By calibrating and synchronizing (e.g., time and spatially) the imaging system 1010 and the sports ball tracking system (e.g., the radar 1020), data from the radar 1020 and the imaging system 1010 may be used to determine the position over time of the non-spherical object 1030 captured in each of the images picked up by the imaging system 1010.

The image series captured by the imaging system 1010 and the doppler radar signal recorded by the radar 1020 are supplied to a processor 1040. The processor 1040 is configured to detect pixel positions corresponding to an outline of the non-spherical object 1030 in each of the images so that a portion of each image corresponding to the non-spherical object 1030 may be identified in each of the images permitting changes in the size, location and/or orientation of the portions of the images corresponding to the non-spherical object to be used to construct data relating to the movement of the non-spherical object throughout a time span represented by the series of images. As would be understood by those skilled in the art, the processor 1040 may, in an exemplary embodiment, apply any of a variety of standard programs such as Canny edge detection, Sobel edge detection, or Laplacian edge detection, etc. to identify edges (outlines) of the portion of each image corresponding to the non-spherical object 1030. Also, characteristic points and lines may be detected this way.

As would also be understood by those skilled in the art, a Convolutional Neural Network (CNN) may be applied to automatically detect the non-spherical object in the images. The processing of the Doppler radar signal may involve any or all of pulse compression, matched filtering, thresholding, range detection, clutter rejection, Doppler processing, and Doppler detection to improve the range resolution, signal-to-noise ratio and/or to remove unwanted echoes. Due to the calibration of the imaging system 1010 and the radar 1020 to one another, data from the radar 1020 may also be used by the processor in determining the position of the non-spherical object 1030 in any or all of the images and to calculate the position, rotation, orientation and/or path of movement of the non-spherical object in relation to coordinates in the real world (e.g., in relation to a position of the non-spherical object as it moves through a space adjacent to a sporting field of play).

The system 1000 may also comprise a memory 1050 configured to store the series of images captured by the imaging system 1010 and the data from the radar 1020. Processed images and/or parameters relating to a track of the non-spherical object may also be stored in the memory 1050. The processor 1040 may then present processed and/or raw data in any known manner (e.g., on a display 1060), e.g., under the control of an operator or automatically as would be understood by those skilled in the art.

At least one imager of the imaging system 1010, the radar 1020 and the processor 1040 may be integrated into a single device or may be included in two or more separate devices. In one embodiment, the processor 1040 is integrated into a computing device, in another embodiment the processor 1040 is integrated into a device also hosting at least a portion of the imaging system 1010, the radar 1020 or both.

A quarterback in football plays an important and complex role. The quarterback is the on the field leader of the offense responsible for making quick decisions, adjusting plays, and ensuring that the offensive strategy is executed effectively (e.g., passing the ball or handing it off to a running back). The quarterback directs plays and serves as the main point of communication between the coaches and the rest of the team. As the playmaker, the quarterback must make split-second decisions (e.g., considering defensive formations and adjusting plays accordingly) to maximize their team's chances of success.

When throwing a football, achieving a spiral can be crucial to permit long passes to cut through the wind and reach their destination quickly and accurately. A good spiral throw may make approximately 600 rotations (turns) per minute (rpm) so that the direction of the football curves slightly depending on the arm with which it was thrown (i.e., the direction of spin of a right handed throw is opposite that of a left handed thrown generating an oppositely directed curving force due to the rotation of the ball).

A ball thrown by a right-handed quarterback generally has a clockwise spin (when looked at from the quarterback's point of view) while a ball thrown by a left-handed quarterback will have a counterclockwise spin from this viewpoint. Thus, balls thrown by right handed quarterbacks tend to curve from the quarterback's right toward the left while balls thrown by left handed quarterbacks' curve in the opposite direction due to the Magnus effect (i.e., air pressure differences around the spinning object). A well-executed spiral benefits both the distance and accuracy of a throw while the centrifugal force generated by the tight spiral also improves the ability of a catching player to anticipate the path of the thrown ball as it makes the path of travel of the ball more predictable.

Embodiments described herein, enable enhanced training of players throwing such non-spherical objects (e.g., quarterbacks in American football). By tracking the football in flight and predicting the trajectory efficiency and how tight a dispersion pattern for a given thrower is (i.e., how closely the balls thrown adhere to a target trajectory), the system may become a valuable training tool with data-driven insights for players and coaches. The trajectory efficiency may be calculated as a three-dimensional optimizer of how far a player may throw a ball and how close the actual throws are to an ideal trajectory.

When the system 1000 is used for training players, the imaging system 1010 and the radar 1020 may be linked to or incorporated into a launch monitor including a processor and memory or may use any combination of included or networked processors, memories and processing devices as would be understood by those skilled in the art. The radar 1020 and the imaging system 1010 may be calibrated when manufactured (e.g., when these components were embedded in the same device) or may be calibrated to one another by an end user to account for changing geometric/spatial relations to one another whether they are embedded in a single housing or are physically separate items.

In one embodiment, the radar and/or the imager may be positioned so that the field of view of one or both of these devices may be oriented from behind the player throwing the ball although many other geometric arrangements of these components may be used. Alternatively, the positioning of multiple components (e.g., multiple cameras and/or radars) at different locations around a field of play may be used in any combination to ensure that the data captured is sufficient to make the desired analyses of throws, kicks, etc. from different locations on the field and in different directions from these locations.

FIG. 12 illustrates a non-spherical object 1030 (e.g., an American football) in flight seen from a position orthogonal to a travelling direction 1210 (e.g., a path) of the non-spherical object 1030 with a contour of the non-spherical object 1030 captured in a later image of an image sequence overlaid on the image of the non-spherical object 1030 so that the centers of mass 1217 of the non-spherical object 1030 from both images coincide with one another. As the outlines of the non-spherical object 1030 from these two images are not aligned with one another, this indicates wobble of the throw (i.e., the throw is not a perfect spiral). This may be done without generating a composite image. As would be understood by those skilled in the art, the processor may simply compare, between two or more images, a pixel position for each of one or more representative points on the non-spherical object 1030 relative to a pixel position of the center of mass to identify and measure any misalignment of the non-spherical object 1030 between the images in the same manner as if a composite image had been generated.

In a preferred embodiment, a frame rate of the camera is at least 500 frames per second and more preferably 1000 frames per second. At this rate, the distance travelled by a football between frames is negligible (for a pass thrown at 25 m/s the football will travel only 25 mm between frames at 1000 frames per second). Thus, the change in the angle of the football due to the arc of its trajectory over this time period is negligible. However, if slower frame rates are used (especially for passes thrown at higher speeds) the trajectory of the football must be tracked (e.g., using the radar 1020) and a change in the angle of the travelling direction 1210 of the ball must be compensated for in the comparison of the positions of the images of the football in consecutive frames from the imager. Please note that this applies to all embodiments and measurements of spinning and/or toppling balls.

As passes generally have a speed of rotation of approximately 600 rpm, the frequency of the wobble will be 300 per minute (or 5 per second). Thus, from a single image it is possible to calculate the wobbling angle for a thrown football. However, accuracy of this calculation can be improved using additional images as would be understood by those skilled in the art. In addition, as would be understood by those skilled in the art, it is possible to calculate a wobbling frequency by reviewing a series of images to determine a time (calculated based on the frame rate of the imager) required for a characteristic point 1320 to complete a full revolution. In a spiral throw, the spinning axis 1215 of the non-spherical object 1030 will be the major axis of the non-spherical object 1030. With such a throw the quarterback transfers more of his power into the non-spherical object 1030 increasing an initial velocity of the non-spherical object 1030 in the travelling direction 1210.

As discussed above, a tightly spun pass is more likely to stay on a line reducing air resistance to its flight further enhancing the flight characteristics of the non-spherical object 1030. The wobbling angle is defined as the angle between the spinning axis of the non-spherical object 1030 and the travelling direction 1210. Those skilled in the art will understand that the flight path of the non-spherical object 1030 need not be orthogonal to the imager(s). Rather, the imaging system 1010 will generally include multiple imagers and images may be selected from one or more of these imagers that are most useful in making the desired calculations.

For example, for a football game, the imaging system 1010 may include three imagers, one in each end zone facing the field of play and one on a side of the field of play facing the field of play. Of course, any additional number of imagers may be added to the system to ensure that all passes are captured sufficiently for the desired analysis (e.g., including a fourth imager on the opposite side of the field of play from the third imager). It is likely that many of the passes will be thrown along paths of travel that are angled relative to one or all of the imagers (i.e., that are not exactly parallel or orthogonal to a line of sight from one or all of the imagers). In any case, this will permit the system to select images from the imager that provides the images most suitable for the analysis of a given pass (or may utilize a combination of images from multiple imagers as desired). Furthermore, as described below in more detail, for practice sessions a player may be directed to throw or kick the ball along any desired path so that the system is oriented in a desired manner relative to the path along which the ball travels.

As indicated above, the spinning of the non-spherical object 1030 creates a difference in air pressure between opposite sides of the non-spherical object 1030, causing its path of travel to curve in the direction of the lower pressure and which also introduces a slight wobble into the motion of the football 1300. The amount of wobbling due to the Magnus effect depends on several factors, including the speed of the throw, the spin of the ball, and the air density. A faster throw and higher spin will result in more wobbling, while denser air (e.g., when it is cold) will have a greater impact on the ball's flight. However, although a portion of the wobble of the non-spherical object 1030 may be caused by the pressure differences resulting from the Magnus effect, this has a negligible impact on the total wobble which is caused for most practical purposes due to imperfections in the throwing motion.

Wobbling of a ball in a good spiral throw (i.e., due to Magnus effects and not only to imperfect technique in throwing the football) causes the nose 1225 of the football to circle around (marked with arrow 1228) the travelling direction 1210. The angle between the travelling direction 1210 of the non-spherical object 1030 and its spin axis 1215 is a measure for the wobbling and may be called a wobbling angle 1226. Together with ball speed, spin frequency, etc., a measure of the wobbling angle 1226 will be a valuable input for a trainer team training a quarterback, as these data may be the basis for data driven training sessions.

Weather conditions may also have a significant impact on the wobbling of the football. In addition to the role of air density mentioned above, wind speed and wind direction may also affect the flight of the football and cause it to wobble. Professional football players have mastered the ability to control the wobble of a football through their throwing technique. By adjusting the angle and speed of the throw, as well as the spin on the ball, they can accurately deliver passes to receivers over distances long and short.

In another embodiment, the displacement of the predetermined characteristic point 1320 or the radius of the circle is measured as a number of pixels in the image from the imager. The range from the radar 1020 and the displacement of the characteristic point 1320 is used to calculate the angle between the travel direction and the spinning axis of the non-spherical object 1030. Hereby the wobbling angle may be derived in step 1170.

In one embodiment, the relationship between multiple wobbling angles and the displacement of the characteristic point 1320 has been determined in advance, so is just a matter of looking up in a table, once the displacement of the characteristic point 1320 in the image analyzed has been determined. Knowing the distance from the imaging system 1010 to the non-spherical object 1030 and the dimensions of the non-spherical object 1030, the processor 1040 may determine the actual value of the displacement from the displacement measured in pixels. Knowing the dimensions of the non-spherical object 1030, the processor 1040 may determine the actual value of the displacement from the displacement from the displacement measured in pixels and the outline of the non-spherical object 1030 measured in pixels.

In a yet further embodiment of the disclosure, the system 1000 for determining a wobbling angle of a spinning non-spherical object comprises an imaging system 1010 including an imager having a field of view through which the non-spherical object 1030 passes along the travelling direction 1210. The imaging system 1010 is configured to generate a series of images of the non-spherical object 1030 at a predefined frame rate. The processor 1040 is connected to the imaging system 1010. The processor 1040 is configured to identify a predetermined characteristic line, e.g., the minor axis 1331 or the major axis 1332 of the spinning non-spherical object 1030 in each of a plurality of the images. Furthermore, the processor 1040 is configured to determine the travelling direction 1210 of the non-spherical object 1030 in each of a plurality of the images. By detecting the outlines of the non-spherical object 1030 in the images, the travelling direction 1210 may be determined as the change in pixel position for selected portions of the image of the non-spherical object 1030 from one image to the next. Finally, the wobbling angle can be determined as the angle between the travelling direction 1210 and the predetermined characteristic line (e.g., major axis) of the non-spherical object 1030.

This embodiment is especially suited, when the imaging system 1010 is placed generally orthogonal to the travelling direction 1210 of the non-spherical object 1030 when it is thrown by a player (e.g., as most passes are thrown down the field toward the endzone, these images will best be captured by a camera on the side of the field of play). However, for passes thrown laterally across the field of play, the line of sight from one or both of the endzone cameras will be closer to orthogonal to the travelling direction 1210. Such passes may be better captured by other cameras on the sidelines, for example.

FIG. 13a shows an example of an American football 1300. The football 1300 is made from four individual leaf-shaped panels of leather that taper at both ends and sewn together. As visible from FIG. 13a, the football 1300 has four characteristics seams 1310 resulting from the assembling of the four leather panels. These seams 1310 meet at a crossing 1325 in each of the ends of the football 1300. When one of these crossings 1325 is identified in one or more images, the system can identify the exact position of the nose 1225 of the football 1300 in each such image. Either of the crossings 1325 may serve as the characteristic point 1320 when analyzing the football 1300 in flight with an image sequence from one or more imagers of the imaging system 1010. In a tightly spun pass, the two crossings 1325 define, respectively, the nose 1225 and the tail 1304 (opposite to the nose 1225) of the football 1300.

FIG. 13b illustrates the football 1300 in flight in two successive images in an image sequence captured by a camara or an imager having field of view generally orthogonal to a travelling direction 1210 of the non-spherical object 1030. The football 1300 has a minor axis 1331 and a major axis 1332.

For example, at a training session, an imager of the imaging system 1010 may be placed behind a quarterback who is to throw the football 1300 so that the processor 1040 may overlay images of the football 1300 (or contours of the football 1300) so that the centers of mass 1217 the images (or contours) of the football 1300 from multiple images coincide with one another. As seen in FIG. 13C, the seams 1310 as seen at the rear end of the football 1300 rotate through the image sequence due to the spinning of the football 1300 while the crossing 1325 at the rear of the football 1300 remains at the same spot.

With wobbling present, the crossing 1325 moves along a circular path 1340 (e.g., when viewed in the travelling direction 1210 as illustrated in FIG. 13d). By applying a Dense Optical Flow application in the processor 1040, it is possible to follow the position of the crossings 1325 of the football 1300 to measure the radius of the circular path 1340 of the crossing 1325 travels during a full wobble (e.g., a full rotation). For example, when the football 1300 is thrown directly away from or toward the imager of the imaging system 1010 the radius of the circular path 1340 can be compared to the known length of the minor axis of the football 1300 to calculate the length of the radius of the circular path 1340. The optical flow of the ball is defined as a motion pattern of elements on the football 1300 between consecutive frames due to the travel of the football 1300. It represents a 2D vector field where each vector indicates the displacement of points from one frame to the next.

In one embodiment, an imager of the imaging system 1010 and the radar 1020 are embedded into a launch monitor device (e.g., within a common housing). This permits this imager of the imaging system 1010 and the radar 1020 may be calibrated and synchronized, so that, based on data from the radar 1020 corresponding to the range from the radar 1020 to the football 1300, the processor 1040 will be able to calculate the distance between the football 1300 and the imager of the imaging system 1010 so that a measure for the wobbling angle 1226 may be calculated as discussed above.

FIG. 11 is a flow chart 1100 illustrating a method for determining the wobbling angle of the non-spherical object 1030. In step 1110 a series of images is captured by the imaging system 1010 over time as the non-spherical object 1030 travels through a field of view of the imaging system 1010. In step 1120, the processor 1040 identifies the non-spherical object 1030 in the analyzed image, e.g., by blob detection. Hereafter, the processor 1040 identifies, in step 1130, the center of mass 1217 for the non-spherical object 1030 in the analyzed image, e.g., by using one of the methods mentioned above. As would be understood by those skilled in the art, the center of mass 1217 of the non-spherical object 1030 in the analyzed image may be determined from the outline of the non-spherical object 1030. The processor 1040 identifies in step 1140 the characteristic point 1320 of the non-spherical object 1030. The characteristic point 1320 of the non-spherical object 1030 may, for example, be the tail 1304 discussed with reference to FIG. 13A or any other identifiable point. The tail 1304 may be visually detected as the crossing 1325 of the four seams 1310.

Once the center of mass 1217 and the characteristic point 1320 of the non-spherical object 1030 have been determined, the processor 1040 determines in step 1150 the displacement in the image (e.g., relative to an immediately previous image) of the center of mass 1217 and the characteristic point 1320. In step 1160, the processor 1040 determines the distance between the imaging system 1010 and the characteristic point 1320 of the non-spherical object 1030 based on data from the radar 1020. When the imager of the imaging system 1010 and the radar 1020 are embodied in one pre-calibrated unit or when the radar 1020 and the imager of the imaging system 1010 are calibrated to one another (e.g., via a separation vector), the radar 1020 provides the data for range or distance measurement between the imager and the non-spherical object 1030.

In one embodiment, the processor 1040 is configured to determine the wobbling angle 1226 relative to the travelling direction 1210 in one or more further images. The processor 1040 may then be configured to determine an average value for the wobbling angles 1226 through a plurality of images.

In one embodiment, the displacement of the characteristic point 1320 or the radius of the circular path 1340 is measured as a number of pixels in the image from the imager. Knowing the dimensions of the minor axis 1331 and the major axis 1332 of the football 1300, the processor 1040 can determine a number of pixels for the outline radius of the football if it were tightly spinning at the same distance and on the same line of sight. The processor can then calculate the wobbling angle between the travelling direction 1210 and the spinning axis in step 1170.

In American football, the ball may on some occasions be kicked. The kickers transfer of energy from foot to football is significantly different from the quarterback's transfer of energy to the passed football. Punted balls can often spiral, but these kicks generally spin around an axis that is not coincident with the path of travel of the ball. All other kicks generally topple significantly. The toppling flight from kicking, especially from footballs that are not punted, generally involves rapidly changing angles between the major axis 1332 of the football 1300 and its direction of motion, which makes it more complex to analyze compared to a tightly spun pass from the quarterback or a spiraling punt. When studying placekicks, it has been observed at that impact location and angle, as well as the effects of stagnant air drag on football trajectories. E.g., for placekicks and field goal/extra point attempts, an impact location approximately 2 inches from the bottom of the ball maximized trajectory height and distance. Toppling ball flight in American football, plays a significant role in the game's dynamics.

Kicking the ball closer to its bottom tends to reduce toppling and optimize trajectory height and distance. A proper kicking technique including a clean strike with the foot's center of mass hitting the ball may also reduce toppling. By avoiding off-center impacts, unwanted spin may be reduced. A reduced spin rate reduces the Magnus effect (which causes the ball to curve) and may decrease toppling. By lowering the launch angle, a flatter trajectory is obtainable. This may minimize toppling but also affects distance. However, toppling is inherent due to the ball's shape and aerodynamics, but by adjusting kicking technique the toppling may be reduced. The disclosed embodiments provide technology generating data useful in training sessions for kickers.

FIG. 14a illustrates the flight of a kicked non-spherical object 1030 (e.g., an American football) moving along the travelling direction 1210 seen from a position substantially orthogonal to the travelling direction 1210. The non-spherical object 1030 topples (rotates end-over-end) as marked with the arrow 1420 when travelling along the travelling direction 1210.

FIG. 14b illustrates an image of a non-spherical object 1030 (e.g., an American football) captured by an imager of an imaging system 1010 positioned behind the player that kicked the non-spherical object 1030 as a placekick. An image of the non-spherical object 1030 captured by the same imager in a second position 1030*, is overlaid over the image of the non-spherical object 1030 from the first image with the centers 1425 of the non-spherical object 1030 from the first and second images coinciding with one another. In the first image, the non-spherical object 1030 is positioned so that the major axis of the non-spherical object 1030 is substantially perpendicular to a line of sight from the imager so that the oblong shape of the non-spherical object 1030 is visible.

As can be seen in FIG. 14b, the non-spherical object 1030 in the second position 1030* has rotated 90 degrees compared to the orientation of the non-spherical object 1030 in the first image so that the non-spherical object 1030 appears to be circular as the line of sight from the imager to the non-spherical object 1030 is substantially parallel to the major axis in the second position 1030*. As indicated previously, a composite image need not be generated to perform this analysis. Rather, the processor may simply calculate the position of any point or points on the non-spherical object as a pixel displacement relative to the center of mass of the object (as depicted in the image) and compare these displacements in different images to determine the misalignment of one or more characteristic points on the non-spherical object 1030 as it travels. All the vectors, angles, axes, and planes described herein may then be computed in the same manner based on these relative measurements without generating any composite image.

As the toppling non-spherical object 1030 rotates in this example with the major axis of the non-spherical object 1030 parallel to a vector 1422 (perfect end-over-end rotation) so that the rotation of the non-spherical object 1030 defines a toppling plane perpendicular to a vector 1460 (i.e., the normal vector) which in this case is the minor axis of the non-spherical object. The vector 1460 lying in the plane of the captured image defines the toppling axis of the non-spherical object 1030. In this case, the crossings 1325 of the seams 1310 of the non-spherical object 1030 (football 1300) at both ends of the football 1300 are selected as the characteristic points 1320. The characteristic points 1320 will, in the image projection shown in FIG. 14b, travel along a bold black line 1321 that lies in the toppling plane.

By applying a Dense Optical Flow application in the processor 1040, the position of the crossings 1325 travelling along the line 1321 may be identified and, when the processor 1040 compares this line 1321 to a known vertical direction (indicated by a line 1450 and determined in any of a variety of known manners) to determine a toppling angle 1424 between the toppling plane and the vertical.

FIG. 15a illustrates a toppling non-spherical object 1030 (e.g., the football 1300) where the football 1300 topples so that the major axis 1332 of the football 1300 is not parallel to the toppling plane. In this example, a vector 1460 is the normal vector. Due to the nature of this toppling, the crossings 1325 of the seams 1310 at both ends of the football 1300 move as the football 1300 topples along respective circular paths parallel to the toppling plane as seen in FIG. 15b.

As would be understood by those skilled in the art, the paths described herein as circular (e.g., the paths of rotation of the ends of the toppling or wobbling football) are circular only in a frame of reference moving with the center of mass of the football 1300 as would be seen when images from different times in the flight of the football 1300 are overlaid on one another as described herein. When seen in images taken by an imager positioned behind the kicker of the football 1300 (or, in images taken by an imager positioned in front of the kicker) with the centers of the images of the football 1300 overlaid on one another, the crossings 1325 of the seams 1310 of the football 1300 will appear to travel back and forth along two straight (dotted) lines 1510. During the toppling, the major axis 1332 of the non-spherical object 1030 as shown in any two images will form an “X” in the overlaid images from an image sequence showing multiple instances of the toppling football 1300 with the centers of the images of the football 1300 overlaid on one another.

This may be seen when a first image shows the ball with it largest dimension visible, and when a second image shows the ball end-over end rotated 180 degrees. As indicated below, images showing the football 1300 in positions where the major axis is longest (i.e., images where the major axis is most nearly parallel to the image plane) will show an “X” that is symmetric with respect to the toppling plane. Thus, these images as shown in FIG. 15b may be used to identify the toppling plane and to determine the offset angle 1520 as will be described below. However, those skilled in the art will recognize that the same geometric relations may be derived using any two images of the football 1300 separated by 180 degrees of toppling or by any two images that allow the identification of one of the lines 1510. That is, if one of the lines 1510 is identified as those skilled in the art would understand, the other line 1510 may be identified by analyzing the shapes of the football 1300 in the two selected images in view of the known geometric properties of the football 1300 (e.g., knowing the ration of major axis to minor axis and the cross-sectional shape of the football 1300 (i.e., the shape of the football 1300 in an image taken perpendicular to a plane including the major and minor axes).

The processor then identifies the offset angle 1520 as half the angle α formed by this “X” representing the major axis 1332 in the images of the image sequence. A vector 1422 that divides the angle α in half defines the toppling plane for the football 1300. The angle α is twice the offset angle 1520. The processor 1040 then compares the vertical direction indicated by the line 1450 to the vector 1422 to determine a toppling angle 1424 formed between the toppling axis and the line 1450.

FIG. 16 is a flow chart 1600 illustrating a method for determining a toppling axis of the football 1300. In step 1610 a series of images is captured by the imaging system 1010 over time as the football 1300 travels through a field of view of one or more imagers of the imaging system 1010 including, for example, a first imager placed behind a player kicking the football 1300. In step 1620, the processor 1040 identifies the football 1300 in the analyzed image, e.g., by blob detection. Thereafter, the processor 1040 identifies, in step 1630, the center of mass 1217 for the football 1300 in the analyzed image (e.g., based on the outline of the football 1300 in the image). The processor 1040 identifies in step 1640 one or more predetermined characteristic points 1320 of the football 1300 such as, for example, the tail 1304 and/or the nose 1225 of the football 1300 (e.g., by detecting one or both of the crossings 1325 of the seams 1310 of the football 1300).

Once the center of mass 1217 and the characteristic point 1320 of the football 1300 have been determined, the processor 1040 overlays, in step 1650, multiple images of the football 1300 from a sequence of images of the football 1300 in flight so that the centers of mass 1217 of the football 1300 in the various images overlap to determine a travelling path of the characteristic point 1320 in the overlaid images. As indicated earlier, the processor need not actually overlay any images. Rather, the processor may simply make determinations of the location in each image of one or more points relative to the location of the center of mass in that image. These relative locations may then be compared in the same manner as would be done in an overlaid composite image to determine the motion of these points in the plane of the images relative to the center of mass.

Once the travelling path of the characteristic point 1320 has been determined, the “X” formed by the major axis 1332 (detected, for example, based on the image of the seams 1310 extending along the major axis 1332) is identified in step 1660 and the offset angle 1520 is determined as half of the angle α formed by “X” of the major axis 1332. As indicated above, the offset angle 1520 is determined as half the angle α. As would be understood by those skilled in the art, when the offset angle 1520 is zero (or close to zero), the toppling of the football 1300 is a substantially pure toppling movement.

Alternatively, the path of a second point (e.g., a second end of the football 1300 opposite the point 132) on the opposite side of the center of mass of the football 1300 from the first characteristic point 1320 may be tracked as well. As can be seen in FIG. 15b, the paths traced out by the first and second points in the images will generate two lines parallel to one another. A line parallel to and midway between these lines (when the first characteristic point 1320 and the second point are equidistant from the center of mass) is the vector 1422 that can then be compared to the vertical to determine the offset angle 1424 as described below. More particularly, the line between the paths traced out by the first characteristic point 1320 and the second point that represents the vector 1422 will be parallel to these paths and will pass through the center of mass of the football 1300. As would be understood by those skilled in the art, using more than two images and/or using images in which the separation in the two images between the positions of the first characteristic point and the positions of the second characteristic point are greater, can enhance the accuracy with which the parallel lines, and hence the vector 1422 can be identified.

The processor 1040 may then compare, in step 1670, the known vertical direction indicated by the line 1450 to the toppling plane T defined by the line dividing the angle α in half. That is, the toppling angle 1424 between the vector 1422 representing the toppling plane T and vertical. The toppling angle 1424 indicates how much the toppling plane is tilted relative to vertical.

Advantageously, the imager(s) of the imaging system 1010 will have a frame rate selected so that the images analyzed in step 1650 fulfill the Nyquist theorem in relation to the toppling/toppling frequency of the non-spherical object 1030.

Together with ball speed, spin frequency, etc., a measure for the toppling angle 1424 and the offset angle 1520 is valuable input for the training of football kickers. This may be especially valuable in helping kickers train to control and/or avoid types of toppling that make the flight of the ball unstable. Especially for field goal and extra-point kicks in which accuracy and distance are required to score points, a high degree of stability in the flight of the kicked ball is desired.

In other situations (e.g., to minimize the chance of a long return of a kick), it may be desirable to have a more unstable flight of the ball. Furthermore, when punting, it may be desirable to achieve a tight spiral (i.e., to minimize toppling) as this is generally associated with greater distance and a higher degree of accuracy.

In one embodiment, the relationship between multiple offset angles 1520 (α/2) and a distance of displacement of a predetermined characteristic point 1320 (e.g., at an end of the football 1300) during a full rotation of the football 1300 may be determined in advance and stored in a table. Alternatively, the calculations below may be performed for each analysis in the same manner described for the calculation of the entries in the table. In this case, the processor of the system would need only to measure a maximum distance D between positions of the characteristic point 1320 in various images and then, knowing the distance from the imaging system 1010 to the football 1300 (e.g., based on data from a tracking device such as a radar) and the dimensions of the football 1300, the processor may determine the actual value of the displacement D (e.g., in cm) from the displacement measured in pixels. For example, where the characteristic point 1320 is at one end of the major axis of the football 1300, the table of the angles 1520 (α/2) may be compiled, for example, for each of a range of values for D from a maximum where D equals the length MA of the major axis of the football 1300 (α=0) to a minimum where D is 0 (α/2=90 degrees). As would be understood by those skilled in the art, these calculations may be made based on the fact that the cosine of the offset angle 1520 (α/2)=D/MA.

In one embodiment, for a training session, the radar is positioned behind or directly in front of a location from which the ball is to be thrown. That is, in the training session, the player will be asked to throw the ball from a point on a target line so that the field of view of the radar is directly aligned with the plane within which the ball will be thrown. For example, a target may be positioned on a playing surface along with a marking or other indicator of a desired throwing location or desired throwing line leading to the target. The radar in this embodiment is positioned on this desired throwing line at a location behind the desired throwing location or directly in front of the desired throwing location.

The player will then be asked to throw the ball from the desired throwing location toward the target so that the ball travels in a plane directly aligned with the radar. An imager may also be positioned on the target line either in front of or behind the desired throwing location and/or in a desired position transverse to the desired throwing line so that the field of view of the camera will be substantially perpendicular to the plane within which the ball is travelling. As would be understood by those skilled in the art although many other geometric arrangements of these components may be used, or additional components may be added to the system in various locations to ensure that the data captured is sufficient to make the desired measurements.

As shown in FIG. 17, a system 1700 includes a radar 1710 positioned on the playing field 1712 behind a desired throwing location 1714 and a target 1716 is positioned downfield from the throwing location 1714 along a line 1718 that connects the target 1716, the throwing location 1714 and the radar 1710. Those skilled in the art will understand that all of the techniques and measurements made by the system 1000 may be made as well by the system 1700 in the same manner. The significant difference between the system 1700 and the system 1000 being the manner in which the system is operated and the manner in which the player interacts with the system. That is, the system 1700 is explicitly designed for use in non-game situations in which the measuring equipment (e.g., radar, camera, etc.) may be placed in any desired locations on the field and the player can be directed to throw or kick the ball in a desired direction from a desired location on the field (in contrast to the unpredictability and wide variation in throwing and kicking paths and directions during game situations.

An imager 1720 (e.g., a camera) is positioned on one side of the playing field oriented so that the field of view 1724 of the imager 1720 includes the area into which the ball will be thrown and so that an image plane 1726 of the imager 1720 is substantially parallel to the plane 1728 within which the ball 1730 will be travelling when thrown by a player from the location 1714 along the line 1718. As would be understood by those skilled in the art, the throwing location 1714 may be any location on the line 1718 that is between the radar 1710 and the target 1716. That is, the player may throw from any location on the line 1718 so long as the ball is directed substantially along this line, the system 1700 will be able to analyze the flight of the ball 1730 in the same manner as described above in regard to the analysis of the flight of the non-spherical object 1030 and may do so in a more accurate manner as the flight of the ball 1730 is more closely located along the line 1718. For example, as those skilled in the art will understand, much of this data may be obtained through the use of a system 1700 that does not include a radar 1710 (i.e., which relies only on the analysis of images from the imager 1720) or a system 1700. A radar may be used to provide data regarding the determination of the travel path of the football 1300 (line 1718) which may then be used in conjunction with imager data for further analysis.

Furthermore, it will be understood by those skilled in the art, that a player may simulate nearly any passing situation by varying the player's approach to the line 1718. For example, in a first situation, a player may simulate conditions where a quarterback throws a pass from the standard position (e.g., after having dropped back into the pocket) by assuming his stance on the line and throwing downfield. The player may set up his stance as if to throw from the throwing location 1714 along a line angled with respect to the line 1718 and then throw along the line 1718 without changing his stance to mimic situations where the quarterback feints in a first direction and throws in a different direction without changing his stance.

The player may also mimic any situation where the quarterback throws while running by approaching the line 1718 from any desired direction and then throws the ball 1730 down the line 1718 toward the target 1716. As would be understood by those skilled in the art, the player may approach the line 1718 from either side at any angle to simulate nearly any type of pass that might be made during game situations. The system 1700 may further include optional functionality permitting a coach to categorize various throws into groups defined, for example, based on the type of throw simulated. For example, throws made along the line 1718 by a right handed player approaching the throwing location 1714 from the right side at an acute angle may be categorized as simulating throws made back toward the center of the field while rolling out to the left, while throws made approaching the location 1714 substantially perpendicular to the line 1718 may be categorized as simulating throws made downfield while rolling right, etc.

Those skilled in the art will understand that the radar 1710 may alternatively be located on the line 1718 in front of the throwing location 1714 (i.e., so that the ball is thrown by the player toward the radar 1710. Furthermore, it is noted that the imager 1720 may be located on either side of the line 1718 (or two cameras may be used with, for example, one on each side of the field).

Thus, as described above, the flight of the ball 1730 will be seen by the imager 1720 from a position orthogonal to the travelling direction of the ball 1730 (i.e., along the line 1718) with a contour of the ball 1730 captured in a sequence of images. As indicated above, these images may be aligned (i.e., so that the centers of mass of the images of the ball 1730 from each of the images coincide with one another). Then, any misalignment between these images indicates wobble of the throw (i.e., the throw is not a perfect spiral).

As indicated above, the high frame rate of the imager 1720 (e.g., 500 or more frames per second), means that the distance travelled by a football between frames is negligible and any change in the angle of the football due to the arc of its trajectory over this time period is negligible. However, as would be understood by those skilled in the art, if slower frame rates are used, this may be corrected for by adjusting an angle of the image of the ball 1730 in one image to counterbalance the change in angle of trajectory (e.g., as measured based on a travel path of the center of mass of the ball 1730 in the images) before measuring any misalignment between the positions of the ball 1730 in different images.

As would be understood by those skilled in the art, in addition to the radar 1710 and imager 1720 described above, any of the equipment arrangements mentioned in the regard to the previous embodiments may be used as a supplement or substitution for any component. For example, the system 1700 may include three imagers, one at either end of the field of play (i.e., one behind the throwing location 1714 and one behind the target 1716 in addition to the imager 1720 on a side of the field of play. Of course, any additional number of imagers may be added to the system to ensure that all passes are captured sufficiently for the desired analysis (e.g., including a fourth imager on the opposite side of the field of play from the imager 1720).

In another embodiment, the displacement of predetermined characteristic point 1320 or the radius of the circle is measured as a number of pixels in the image from the imager. The range from the radar 1020 and the displacement of predetermined characteristic point 1320 is used to calculate the angle between the travel direction and the spinning axis of the non-spherical object 1030. Hereby the wobbling angle may be derived in step 1170.

As indicated above, the relationship between multiple wobbling angles and the displacement of a predetermined characteristic point (e.g., the characteristic point 1320) on the ball 1730 may be determined in advance so, once the displacement of predetermined characteristic point 1320 in the images from the camera 1720 has been determined, the wobbling angle may simply be looked up in a previously compiled table. Knowing the distance from the imager 1720 to the ball 1730 on the line 1718 and knowing the dimensions of the ball 1730, the processor of the system 1700 may determine the actual value of the displacement based on the displacement as measured in pixels. Using the dimensions of the ball 1730, the processor then determines the actual value of the displacement (e.g., in centimeters) based on the displacement measured in pixels and the dimensions of the ball 1730 measured in pixels.

In addition, as indicated above the system 1700 may for determining a wobbling angle of the ball 1730 by identifying a predetermined characteristic line (e.g., the minor axis or major axis of the ball 1730) in each of a plurality of images from the imager 1720. The processor determines a travelling direction of the ball 1730 (e.g., a path along which the center of mass of the ball moves throughout the image sequence) based on analysis of a plurality of the images from the imager 1720 so that the processor can identify the wobbling angle as the angle between the travelling direction of the ball 1730 and the predetermined characteristic line (e.g., major axis) of the ball 1730. Furthermore, as would be understood by those skilled in the art, the system 1700 may employ any of the other methods for determining any characteristic of the flight of the ball 1730 described in this application such as analyzing the motion of characteristic points such as the crossing of the seams of the ball 1730 in images, etc.

For example, in an embodiment of the system 1700 in which a further imager 1722 (e.g., a further camera) is placed behind the throwing location 1714, the processor may overlay images of the ball 1730 from the further imager 1722 (or contours of the ball 1730) so that the centers of mass of the images (or contours) of the ball 1730 from multiple images coincide with one another. Thus, as the seams 1310 seen at the rear end of the ball 1730 rotate through the image sequence due to the spinning of the ball 1730, for a perfect spiral the crossing of the seams at the rear of the ball 1730 remains in substantially the same spot.

When the ball 1730 is wobbling, the crossing of the seams moves along a circular path. As indicated above, the processor of the system 1700 can analyze the motion of the circular path of the crossing of the seams through multiple images to determine the radius of this circular path (e.g., in pixels). Then, knowing the dimensions of the football (e.g., comparing a width of the image of the ball 1730 in pixels to the known size of the minor axis of the ball 1730, the radius of the circular path may be measured, and the wobbling angle may be calculated accordingly.

Those skilled in the art will further understand that the same set-up may be used with a radar 1710 on the field behind a kicker and where the throwing location 1714 becomes a kicking location where the ball 1730 is to be kicked along the line 1718 toward the target 1716. This arrangement may be used in practice sessions to ensure the highest accuracy in analyzing kicks made from a set location 1714 toward a target 1716 in a manner more predictable and convenient than may be done during game situations where cameras and radars must be off of the field of play and where the location and angle of kicks may vary. Furthermore, as would be understood by those skilled in the art, this set-up may be used to analyze any type of kick such as punts, place kicks from a tee, field goal attempts at variable angles (e.g., by changing a width of a target to reflect the foreshortening of the goal posts based on an angle between a kicking location and the goal posts) and extra-point kicks.

Those skilled in the art will understand that the imaging systems described refer to cameras having a fixed position, pan and tilt as well as a fixed focal length. However, for cameras that move, pan, tilt and/or change focal length during the flight of the non-spherical object corrections for all of these changes can be made to ensure the position and size of the non-spherical object in the images can be corrected to compensate for these changes (using known methods) to ensure that calibration to the tracking device (e.g., the radar 1020) remain valid throughout the flight of the non-spherical object.

It will be appreciated by those skilled in the art that changes may be made to the embodiments described above without departing from the inventive concept thereof. It should further be appreciated that structural features and methods associated with one of the embodiments can be incorporated into other embodiments. It is understood, therefore, that this disclosure is not limited to the particular embodiment disclosed, but rather modifications are also covered within the scope of the present disclosure as defined by the appended claims.

1. A system for determining a wobbling angle of a non-spherical object, comprising:
an imaging device having a field of view through which the non-spherical object passes, the imaging device being configured to generate a series of images of the non-spherical object; and
a processor connected to the imaging device and being configured to:
identify, in a first image of the images and a second image of the images, a center of mass of the non-spherical object;
identify a first characteristic point on the non-spherical object in the first and second images;
determine a displacement of the first characteristic point relative to the center of mass of the non-spherical object between the first and second images;
and
determine the wobbling angle based on the displacement of the first characteristic point.

2. The system according to claim 1, wherein the processor is configured to identify in each image a subset of pixels representing an outline of the non-spherical object and determine the center of mass of the non-spherical object based on the outline.

3. The system according to claim 1, wherein the processor is configured to determine a further value for the wobbling angle based on analysis of at least one further image.

4. The system according to claim 3, wherein the processor is configured to determine an average of the wobbling angle and the further value of the wobbling angle.

5. The system according to claim 1, wherein the processor determines the wobbling angle based on a Dense Optical Flow analysis of the first and second images.

6. The system according to claim 1, further comprising:
a tracking device sensing data corresponding to a distance to the non-spherical object, wherein the processor determines the wobbling angle based on a distance to the non-spherical object at a first time corresponding to the first image and a second time corresponding to the second image.

7. The system according to claim 1, wherein the imaging device is positioned so that an imaging plane of the imaging device is substantially perpendicular to a plane within which the non-spherical object is expected to travel.

8. The system according to claim 1, wherein the imaging device is positioned so that an imaging plane of the imaging device is substantially parallel to a plane within which the non-spherical object is expected to travel.

9. A method for determining a wobbling angle of a non-spherical object, comprising:
generating a series of images of the non-spherical object in flight;
determining, for a first image of the images, a center of mass of the non-spherical object;
identifying a characteristic point on the non-spherical object in the first image and a second image of the images;
determining a displacement of the characteristic point relative to the center of mass of the non-spherical object between the first and second images; and
determining the wobbling angle based on the displacement of the characteristic point.

10. The method according to claim 9, further comprising:
determining a distance from an imager to the characteristic point.

11. The method according to claim 10, further comprising:
determining the wobbling angle based on the distance from the imager to the characteristic point.

12. The method according to claim 9, further comprising:
positioning an imager generating the images so that an expected path of travel of the non-spherical object is in a plane substantially perpendicular to an image plane of the imager.

13. The method according to claim 9, further comprising:
positioning an imager generating the images so that an expected path of travel of the non-spherical object is in a plane substantially parallel to an image plane of the imager.

14. The method according to claim 9, further comprising:
identifying in each image a subset of pixels representing an outline of the non-spherical object; and
determining the center of mass of the non-spherical object based on the outline determined.

15. The method according to claim 9, further comprising:
determining a further value for the wobbling angle based on at least one further image.

16. The method according to claim 15, further comprising:
determining an average of the wobbling angle and the further value of the wobbling angle.

17. The method according to claim 9, wherein the non-spherical object is one of an American football, an Australian football, and a Rugby ball.

18. A system for determining a wobbling angle of a non-spherical object, comprising:
an imaging device having a field of view through which the non-spherical object is expected to travel, the imaging device being configured to generate a series of images of the non-spherical object as it travels through the field of view; and
a processor connected to the imaging device and being configured to:
identify a characteristic line of the spinning non-spherical object in a first image of the images and a second image of the images;
determine a travelling direction of the spinning non-spherical object based on the first and second images; and
determine the wobbling angle of the non-spherical object as an angle between the travelling direction and the characteristic line.

19. The system according to claim 18, wherein the non-spherical object is a sports ball having a minor and a major axis and wherein the predetermined characteristic line is the major axis of the sports ball.

20. The system according to claim 19, wherein the imaging device is placed so that an image plane of the imaging device is substantially orthogonal to a plane within which the non-spherical object is expected to travel.

21. A method for determining a wobbling angle of a non-spherical object, comprising:
generating a series of images of the non-spherical object;
identifying a characteristic line of the non-spherical object in a first image of the images and a second image of the images;
determining a travelling direction of the non-spherical object based on the first and second images; and
determining the wobbling angle as an angle between the travelling direction and the predetermined characteristic line of the spinning non-spherical object.

22. The method according to claim 21, wherein the non-spherical object is a sports ball having a minor and a major axis; and wherein the characteristic line is the major axis of the sports ball.

23. The method according to claim 21, further comprising:
placing an imager generating the images so that an image plane of the imager is substantially orthogonal to a plane within which the non-spherical object is expected to travel.

24. The method according to claim 21, further comprising:
placing an imager generating the images so that an imaging plane of the imager is substantially parallel to a plane within which the non-spherical object is expected to travel.

25-45. (canceled)
